(19) United States
(12) Patent Application Publication
(10) Pub. No.: US 2012/0143560 A1
(43) Pub. Date: Jun. 7, 2012

(54) APPARATUS, SYSTEM, AND METHOD FOR PRESSURE MONITORING, DATA HANDLING, AND ONLINE INTERFACE THEREFOR

(75) Inventors: Eddy A. Tabet, Burlingame, CA (US); John A. Murphy, Pacifica, CA (US); Doug W. Miller, San Francisco, CA (US); Lara A. Chan, San Francisco, CA (US)

(73) Assignee: Technology Engineering & Construction, Inc., South San Francisco, CA (US)

(21) Appl. No.: 13/312,877

(22) Filed: Dec. 6, 2011

Related U.S. Application Data
(60) Provisional application No. 61/420,309, filed on Dec. 6, 2010.

(51) Int. Cl. G06F 15/00; G01L 7/20; G01L 19/08

(52) U.S. Cl. 702/140; 73/712; 73/384; 702/188

(57) ABSTRACT

A compliance system for monitoring vapor pressures in storage tanks. Embodiments of the system include data collection systems associated with different storage tanks. Each data collection system collects atmospheric pressure, differential pressure of the tank over the atmosphere, and atmospheric temperature data on a continuous or near-continuous basis. Periodically, the data is transmitted to a host computer, which collects data from multiple data collection systems. The host computer may transmit the data to a web server that makes the data available to any computer via a world wide web interface.

### RELATED APPLICATIONS

This application claims the benefit of the filing date of U.S. Provisional Application Ser. No. 61/420,309, the contents of which are incorporated by reference herein in their entirety.

### FIELD OF TECHNOLOGY

The present disclosure relates generally to pressure monitoring storage tanks or reservoirs, such as, for example, gasoline storage tanks. In particular, the present disclosure relates to an apparatus, system, and method for recording differential pressure, positive or negative, of a storage tank or reservoir compared to atmospheric pressure. In use with gasoline storage tanks, the apparatus, system, and method may be used with storage tanks or reservoirs configured for use with Onboard Refueling Vapor Recovery (ORVR) systems (in which each vehicle recovers its gasoline vapors, as described in more detail below) and also with storage tanks or reservoirs that include vapor recovery equipment (in which gasoline vapors in vehicle fuel tanks are recycled back to the storage tank or reservoir, as described in more detail below).

### BACKGROUND

Various government agencies require that the release of certain hazardous and/or environmentally harmful vapors from storage tanks or reservoirs be prevented or minimized. For example, the California Air Resources Board (“GARB”) requires gasoline vapors at gasoline refilling stations to be captured.

FIG. 1 is a diagram illustrating Stage I and Stage II vapor recovery systems that may be used at a gasoline filling station 100 to prevent vapors from escaping (or to minimize the escape of vapors) into the atmosphere. Stage I prevents or inhibits the escape of vapors during the fueling of the underground storage tank 102 (UST) and Stage II prevents or inhibits the escape of vapors during the fueling of individual vehicles 104. Generally, for both the Stage I system and the Stage II system, gasoline is pumped into or out of the UST 102 through one conduit (e.g., pipe, hose), and vapors are returned through another conduit (e.g., pipe, hose) to prevent the vapor from escaping into the atmosphere. In the Stage I vapor recovery system, liquid gasoline from a tanker 106 is pumped into the UST 102 through a submerged fill pipe 108, and gasoline vapors from the UST 102 are returned back to the tanker 106 through a return pipe 110. When the tanker 106 returns to a bulk terminal (not shown), the gasoline vapor is recycled into liquid gasoline. In the Stage II vapor recovery system, the liquid gasoline is pumped from the UST 102 through a fill pipe 112 into a fuel tank (not shown) of a vehicle 104 through a nozzle 114, and vapors from the fuel tank of the vehicle 104 are returned to the UST 102 through a vapor return line 116. The vapor return line 116 includes a hose from the nozzle 114 to the gasoline dispenser pump 118 and a vapor return pipe from the pump 118 to the UST 102. The nozzle 114 includes a dispensing portion and a boot. The boot is located around the dispensing portion such that the liquid product exits the dispensing portion into the fuel tank of the vehicle 104 and the vapors from the fuel tank go back out through the boot and into a vapor return hose in the gasoline dispenser pump 118 and into the vapor return line 116 that carries vapors back from the gasoline dispenser pump 118 into the UST 102 tank. Older Stage II vapor recovery systems employed a two-hose system while more recent ones employed a coaxial hose system to balance the pressure inside the UST 102.

A gasoline underground storage tank that uses both Stage I and II vapor recovery systems is balanced because there is an equal volumetric exchange of liquid and vapor during the liquid filling or emptying process. In other words, in Stage I vapor recovery systems, the volume of vapor removed from the UST 102 is substantially equal to the volume of liquid pumped into the UST 102 from the tanker 106, thus the pressure in the UST 102 remains substantially balanced. Likewise, in Stage II vapor recovery systems, the volume of vapor returned to the UST 102 is substantially equal to the volume of liquid drawn from the UST 102 and pumped into the fuel tank of the vehicle 104. Therefore, the pressure within the gasoline tank remains substantially constant, and, likewise, the differential pressure of the storage tank compared to atmospheric pressure remains substantially constant.

In recent years, new vehicles are required to be equipped with Onboard Refueling Vapor Recovery (“ORVR”) systems. ORVR is a vehicle vapor emission control system onboard the vehicle that captures fuel vapors from the vehicle gas tank during refueling. An ORVR system includes a Venturi system designed to channel the gasoline vapors from the gas tank to an activated carbon packed canister or tank while refueling the vehicle. The activated carbon packed canister adsorbs the vapor. Subsequently, the operating engine draws the gasoline vapors from the canister into the engine intake manifold to be used as fuel.

ORVR systems reduce volatile organic compounds (VOCs), which are a major cause of urban ozone or smog and toxins in the air. The Environmental Protection Agency (“EPA”) estimates that ORVR systems also will reduce gasoline usage because the gasoline vapors are used in the engine instead of escaping. ORVR systems are required to be installed on 40% of 1998 model year cars, 80% of 1999 model year cars, and 100% of 2000 model year and later cars. Light-duty trucks have a six-year phase-in period, starting in model year 2001. All new cars now are equipped with ORVR systems. By law, once installed in a vehicle, the ORVR system cannot be removed. Removal of the ORVR system is regarded as tampering and will cause the vehicle to not meet EPA standards.

The ORVR system requirement for new cars is a nationwide program for capturing refueling emissions. The ORVR systems eliminate the need for Stage II vapor recovery systems at gasoline refueling stations because gasoline vapors at captured within the vehicle being refueled. Once ORVR vapor emission control system equipped vehicles are in widespread use (probably sometime after 2010) the EPA may revise the requirements so that Stage II vapor recovery controls are no longer be required at service stations in most areas of the country, saving service station owners considerable costs.

In use with cars equipped with ORVR systems, the vapor return line 116 of a Stage II system at a gasoline station 100 may be removed. Accordingly, as liquid is dispensed into the fuel tank of the vehicle 104, no vapor is returned back to the UST 102. When liquid is drawn out of the UST 102 and vapor is not returned, a partial vacuum is created inside the UST 102, resulting in a negative differential pressure compared to atmospheric pressure. Left unchecked, the negative differential pressure eventually could cause the UST 102 to collapse. Accordingly, gasoline stations that service vehicles equipped with ORVR systems require a pressure management system to monitor and balance the pressure within the UST 102.

To address vacuum system imbalance in USTs 102 caused by ORVR vapor emission control systems, local air boards have required certain CARB-approved components be installed at gasoline stations for monitoring and controlling the pressure within the UST 102.

The UST 102 generally includes a venting system with a pressure/vacuum (PV) relief valve to prevent over/under pressurization conditions in order to avoid catastrophic consequences as a result of temperature changes or drawing too much liquid from the UST 102 without vapor replacement. The PV venting system includes a vent pipe (typically an approximately 2″ diameter pipe) extending from the UST 102 and is usually located on the backside of a gasoline station building. The vent pipe goes up above the roof line and includes a PV relief valve on the end of the pipe. Normally, the PV is closed, sealing the UST 102 from the atmosphere. However, if the pressure inside the UST 102 exceeds, for example, approximately three inches of water column above atmospheric pressure, the PV relief valve opens to allow gasoline vapors to escape from the UST 102 to the atmosphere, ensuring that the UST 102 does not rupture from over-pressurization. Likewise, if the pressure inside the UST 102 drops and creates a vacuum of, for example, eight inches of water column below atmospheric pressure, the PV relief valve opens to allow air from the atmosphere into the UST 102, ensuring that the UST 102 does not collapse from the vacuum.

A typical in-station diagnostic system (“ISD”) electronic monitor tracks the UST 102 pressures and generates an alarm under certain criteria to indicate that the UST 102 system pressure is positive or negative for an extended period of time. The alarm may transmit a warning and if that warning is ignored, the system may set off an alarm and, in some circumstances, may shut down the gasoline dispensing pump(s) 118 at the station. In the event of an alarm situation with the vapor management system, local air quality management districts may require that the ISD system automatically disable the gasoline dispensing pump(s) 118 and force the management of the gasoline-dispensing facility to address the vapor recovery problem. Once the issue is addressed, the ISD system enables the dispensing pump 118 to operate properly again. ISD systems are not certified by GARB to work on systems on which the vapor return line has been disconnected.

The foregoing discussion is intended only to illustrate various aspects of the related art in the field of the invention at the time, and should not be taken as a disavowal of claim scope.

### SUMMARY OF THE INVENTION

In various embodiments, a compliance monitoring system is provided. The compliance system includes a data collection system configured to measure pressure of vapors in a liquid storage tank, such as, for example, an underground storage tank for gasoline at a refueling station. The data collection system also may be configured to measure the pressure of the vapors compared to ambient air pressure (called differential pressure). The data collection system also may measure the ambient air pressure and the ambient air temperature. The data collection system may record the pressure and temperature data continuously or nearly continuously, for example, once every second, and then transmit a batch of recorded data to a computer server. The batch of recorded data may be transmitted upon a request for the data from the computer server, such as, for example, when the computer server establishes a computer network connection with the data collection system. The computer server gathers data from the data collection system (and also may collect data from other data collection systems associated with different liquid storage tanks) into a database. A web server communicates with the computer server. The web server receives requests from computer terminals for data from the database. The web server queries the computer server for the requested data. After receiving the requested data, the web server formats the data for display on the computer terminal and then transmits the formatted data to the computer terminal.

### BRIEF DESCRIPTION OF THE DRAWINGS

Non-limiting and non-exhaustive embodiments are described with reference to the following drawings. For a better understanding of the disclosed embodiments, reference will be made to the following Detailed Description, which is to be read in association with the accompanying drawings, wherein:

FIG. 1 is a diagram illustrating Stage I and Stage II vapor recovery systems.

FIG. 2 illustrates a primary tank installation of one aspect of a pressure monitoring system.

FIG. 3A illustrates one aspect of the pressure monitoring system 202 shown in FIG. 2.

FIG. 3B illustrates one aspect of the pressure monitoring system 202 shown in FIG. 2.

FIG. 4 is a schematic diagram of the pressure monitoring system shown in FIGS. 2 and 3.

FIG. 5 is a wiring diagram for one aspect of the pressure monitoring system shown in FIGS. 2-4.

FIGS. 6-9 are graphical illustrations of pressure data collected using one aspect of the pressure monitoring system shown in FIGS. 2-5 for various installations.

FIGS. 10-24 illustrate installations of various aspects of the pressure monitoring system shown in FIGS. 2-5 installed at various gasoline dispensing facilities (GDFs).

FIG. 25 illustrates one aspect of a computing device which can be used in one embodiment of a system to implement the various described embodiments of for a pressure monitoring system and online compliance center.

FIG. 26 illustrates an aspect of a compliance system.

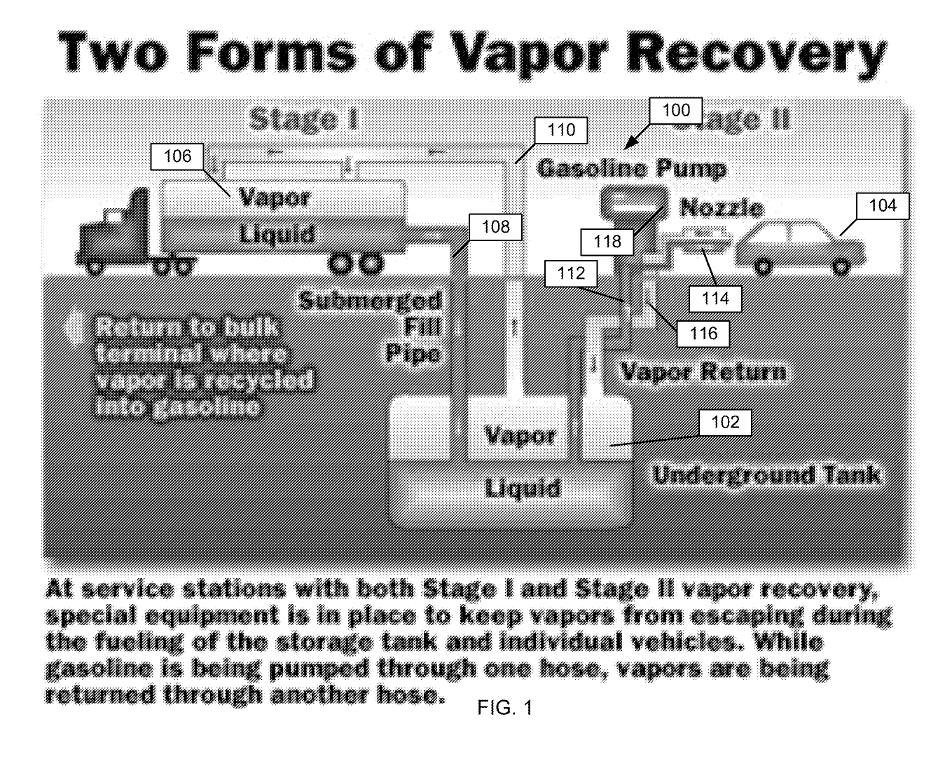

Corresponding reference characters indicate corresponding parts throughout the several views. The exemplifications set out herein illustrate various embodiments of the invention, in one form, and such exemplifications are not to be construed as limiting the scope of the invention in any manner.

### DESCRIPTION

Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Various embodiments of the present disclosure are directed generally to vapor recovery monitoring systems. In one embodiment, the present disclosure is directed to an apparatus, system and method for recording pressure monitoring data from gasoline underground storage tanks (“UST”) equipped with Stage II vapor recovery systems (that can refuel vehicles with Onboard Refueling Vapor Recovery (“ORVR”) systems and vehicles without ORVR systems) and from gasoline USTs that are not equipped with Stage II vapor recovery systems (that only can refuel vehicles equipped with ORVR systems), logging the data, and monitoring the data online via a private or public communication network.

In one embodiment, a continuous pressure monitoring system for a fuel storage tank (e.g., UST 102) records and logs the data, transmits the data to a remote server via a communication network, and an online interface can be employed for monitoring and managing the monitored data. As used herein, the term “continuous” includes periodic measurements in which the period between measurements is not greater than one minute. The continuous pressure monitoring system may follow the testing procedure described in GARB TP-201.7, which is incorporated herein by reference in its entirety, except where the embodiment records and logs the data, transmits the data to a remote server via a communications network, and enables an online interface to monitor and manage the data. The continuous fuel storage pressure monitoring system, data handling, and online interface will be described in the context of private fleet refueling facilities, although the embodiments are not limited to such facilities.

It will be appreciated that private fleets are generally comprised of a large number of late-model vehicles that include ORVR vapor emission controls, which are refueled at a private fleet refueling facility. For example, the Hertz® rental car company may have a refueling station at a car rental location to refuel rental cars that are returned with less than a full tank of gasoline. All of the rental cars in the Hertz® fleet are probably no more than two years old and will be equipped with ORVR systems. Accordingly, the USTs at the refueling station at the Hertz® rental location do not need a Stage II vapor recovery system. A person having ordinary skill in the art will appreciate that the private-fleet refueling station also is descriptive of future general-use refueling stations when a majority of vehicles on the road are equipped with ORVR systems.

Private refueling facilities that had already installed Stage II vapor recovery systems can now be upgraded with a continuous pressure monitoring systems for ORVR equipped fleets according to the present disclosure. Some local US air quality monitoring regulations do not require certification if a private fleet has control over its refueling facilities and at least a certain percentage, for example, over 80%, of its vehicles are equipped with ORVR vapor emission control systems. Accordingly, private fleets that meet these requirements may obtain an exemption that allows them to omit Stage II vapor recovery systems from their refueling facilities. For example, the California Air Resources Board (GARB), or other local enforcement agencies or national agencies, can issue a waiver of its Stage II vapor recovery requirements for private fleets that meet the above criteria. It will be appreciated that different states may employ different requirements and waiver conditions.

The regulations developed by GARB are enforced by local air districts within or outside of California. Once a Stage II waiver is granted by a local air district, the boots located on the dispensing nozzles can be removed and the vapor return lines disconnected. A private fleet refueling facility that meets the GARB exemption requirements will have regular dispensing hoses without a vapor return line because the vapor return line between the dispenser pump and the UST is disconnected. Accordingly, in such installations, there are no vapor return connections between the dispense pump and the UST because all the vapors are being managed in the vehicles equipped with the ORVR vapor emission control systems.

In such refueling facilities without Stage II vapor recovery systems, in-station diagnostic systems (“ISDs”) are not certified by GARB. However, there is a need for continuously monitoring and managing the UST system pressure to ensure that the differential pressure inside the UST compared to atmospheric pressure remains within limits. Preferably, the pressure within the UST remains lower than atmospheric pressure (negative differential pressure) at all times to ensure that there are no fugitive emissions into the atmosphere. One aspect of a fuel storage tank continuous pressure monitoring system will now be described.

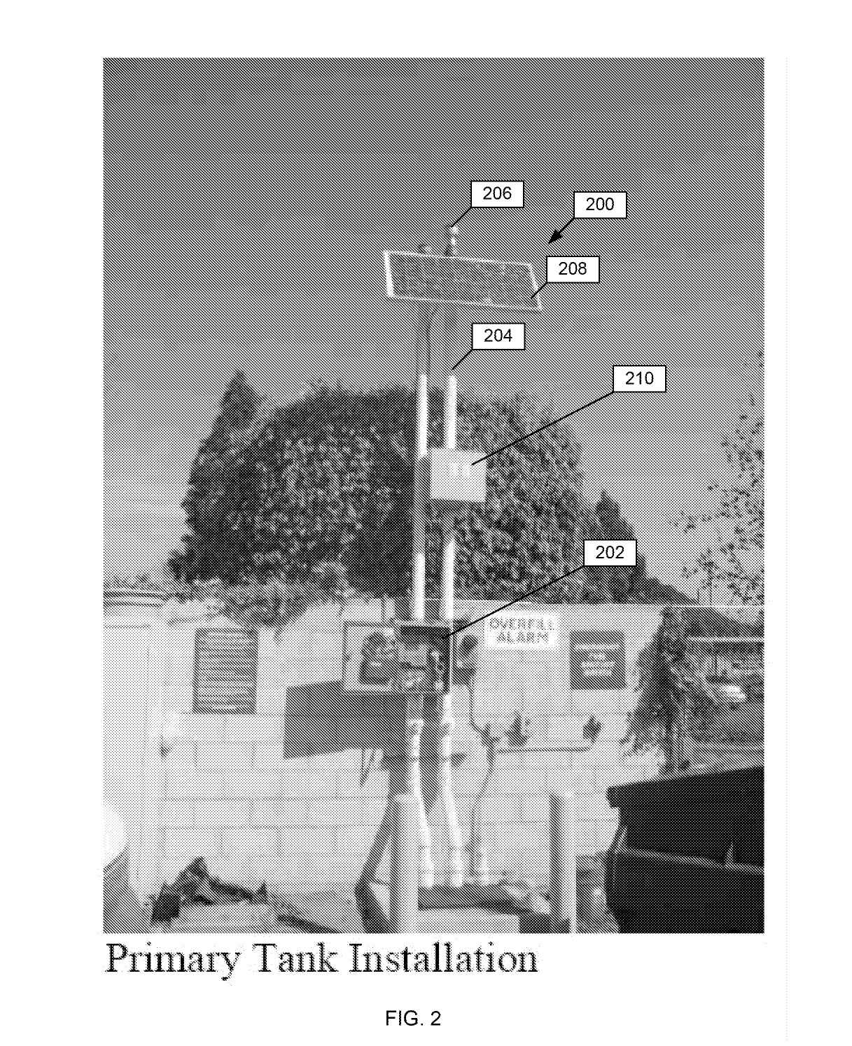

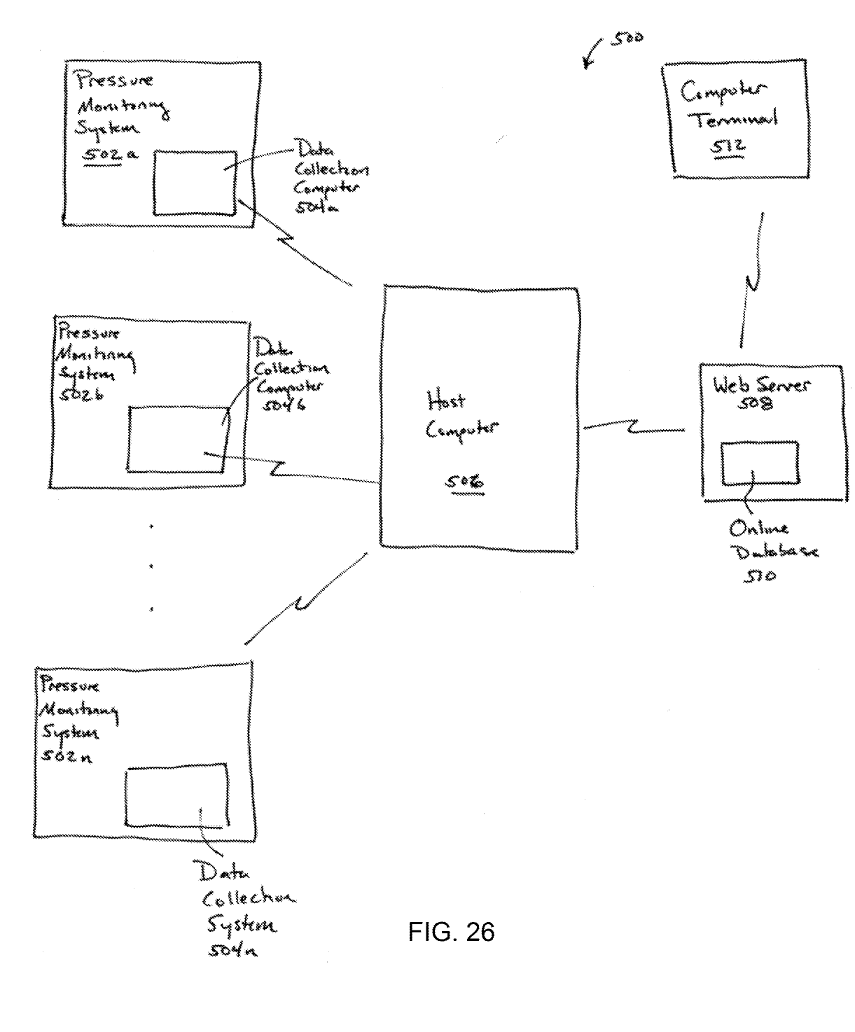

FIGS. 2 and 26 illustrates an embodiment of a pressure monitoring system 202 on a UST installation 200. The pressure monitoring system 202 may be fluidically coupled to an ullage or vapor space of an underground fuel storage tank via venting pipe 204. A pressure/vacuum (PV) relief valve 206 may be located atop the venting pipe 204. The primary tank installation system 200 also may include a solar panel 208 and a back-up battery system 210 to supply electrical power to the pressure monitoring system 202. In one aspect, the pressure monitoring system 202 continuously monitors the pressure inside the underground fuel storage tank, logs the data, and periodically transmits the data to a remote data management system server via the Internet.

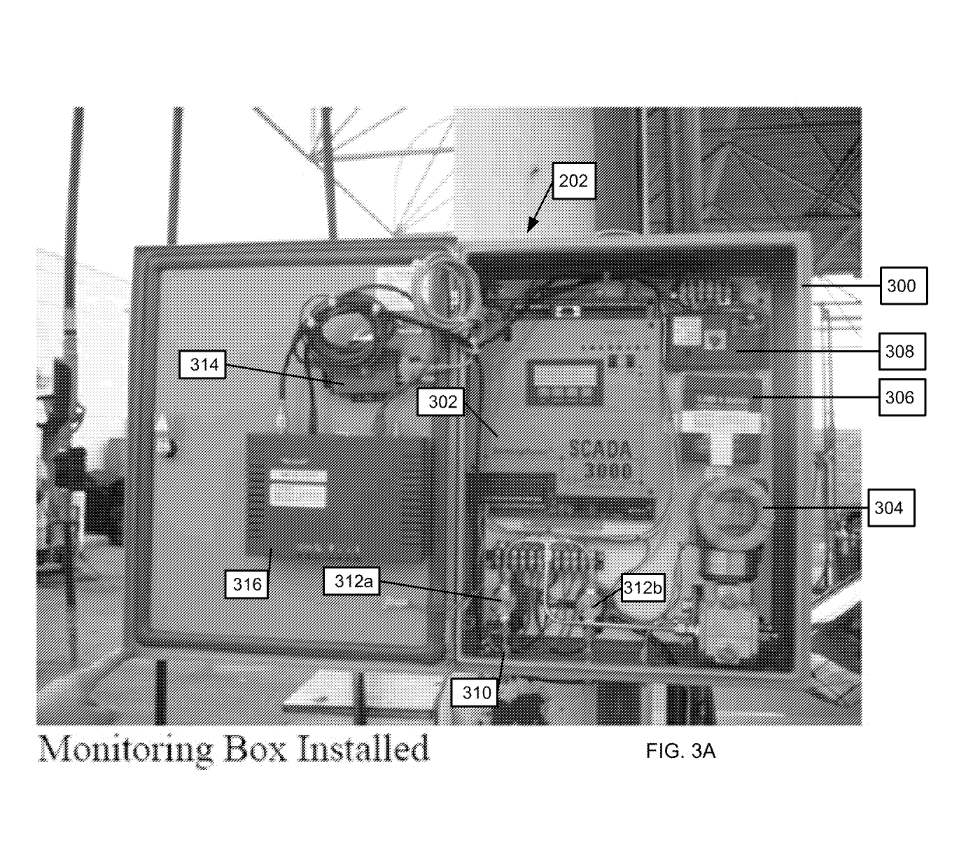

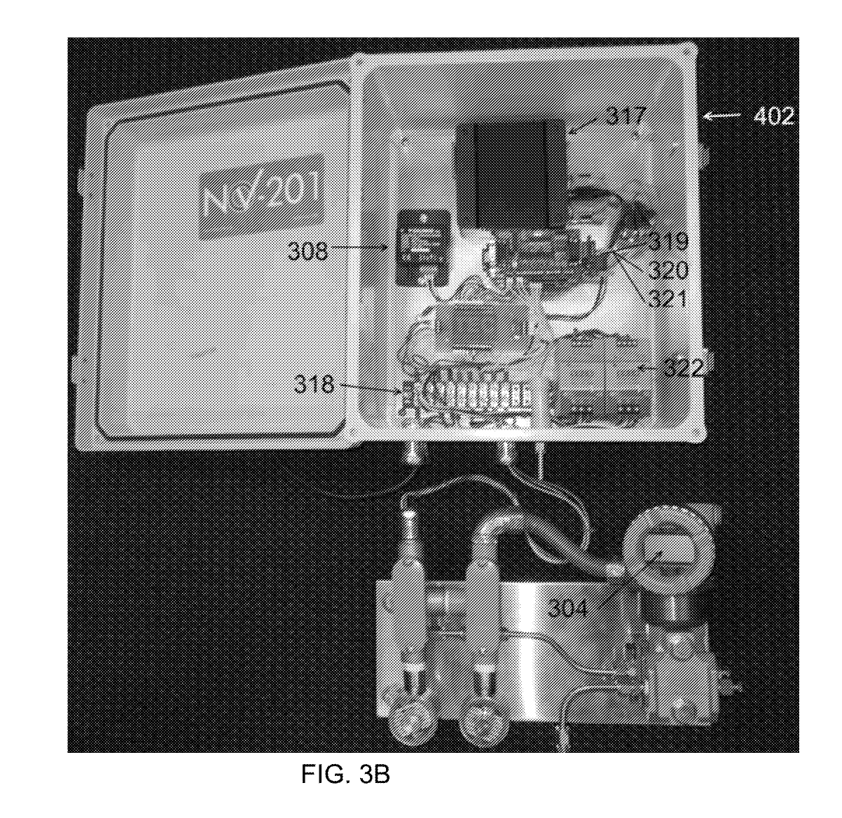

FIGS. 3A and 3B illustrate two aspects of the pressure monitoring system 202 shown in FIG. 2. As shown in FIG. 3A, the pressure monitoring system 202 comprises a housing 300 (housing 402 in FIG. 3B), a data collection computer 302 (317 in FIG. 3B), such as, for example, a Sensaphone SCADA 3000 data logger or a Habey BIS 6620 fanless industrial solid state computer, a differential pressure transducer 304, a battery 306, a barometric pressure recorder 308, a temperature transducer 310 (318 in FIG. 3B), such as, for example, a Sensaphone FGD 0102 thermistor temperature sensor or a VWR Scientific Thermocouple type K, a two-valve pressure calibration system comprising first and second valves 312a, 312b, a serial server device 314 (MOXA), and a modem 316 (e.g., a cellular wireless broadband router). Hereinafter, reference is made solely to the reference numbers used in FIG. 3A. However, a person having ordinary skill in the art understands that the different components identified above in FIG. 3B may be interchangeable with the components in FIG. 3A. For example, future reference to a data collection computer 302 also refers to a data collection computer 317.

With reference now to FIGS. 2 and 3, the battery 306 may be electrically coupled to the back-up battery system 210 and the solar panel 208. In combination, the back-up battery system 210 enables operation of the pressure monitoring system 202 at night. The solar panel 208 may recharge the back-up battery system 210 during the day. In other aspects, the pressure monitoring system 202 may be powered by standard AC power rather than DC power. In other embodiments, the communication to and from the data collection computer 302 may be through wired TCP/IP connections inside or outside of a virtual private network (VPN) instead of through wireless communications.

The differential pressure transducer 304 may be fluidically coupled to valves 312a and 312b of the calibration system in order to calibrate the pressure monitoring system 202 by venting the both sides of the differential pressure transducer 304 to atmospheric pressure. The barometric pressure recorder 308 records atmospheric pressure. The differential pressure transducer 304 measures the pressure inside the UST compared to atmospheric pressure and periodically transmits this differential pressure measurement to the data collection computer 302, which collects the pressure measurements, logs them electronically in memory, and transmits the data serially to other communication devices, which communicate the data using TCP/IP to a remote monitoring device. Additionally, either periodically or on demand, the pressure measurements by the differential pressure transducer 304 are transmitted serially by the data collection computer 302 to the serial server device 314 (MOXA). The serial server device 314 (MOXA) transfers the data from serial to TCP/IP (Transfer Control Protocol/Internet Protocol) to the modem 316. The modem 316 then transmits the data to a remote server over the Internet using the TCP/IP protocol, for example. In one aspect, the modem 316 is a wireless cellular modem (e.g., Tellular), for example. In other aspects, the modem 316 can be a wired or a wireless modem, without limitation, and can transmit the information using any suitable protocol.

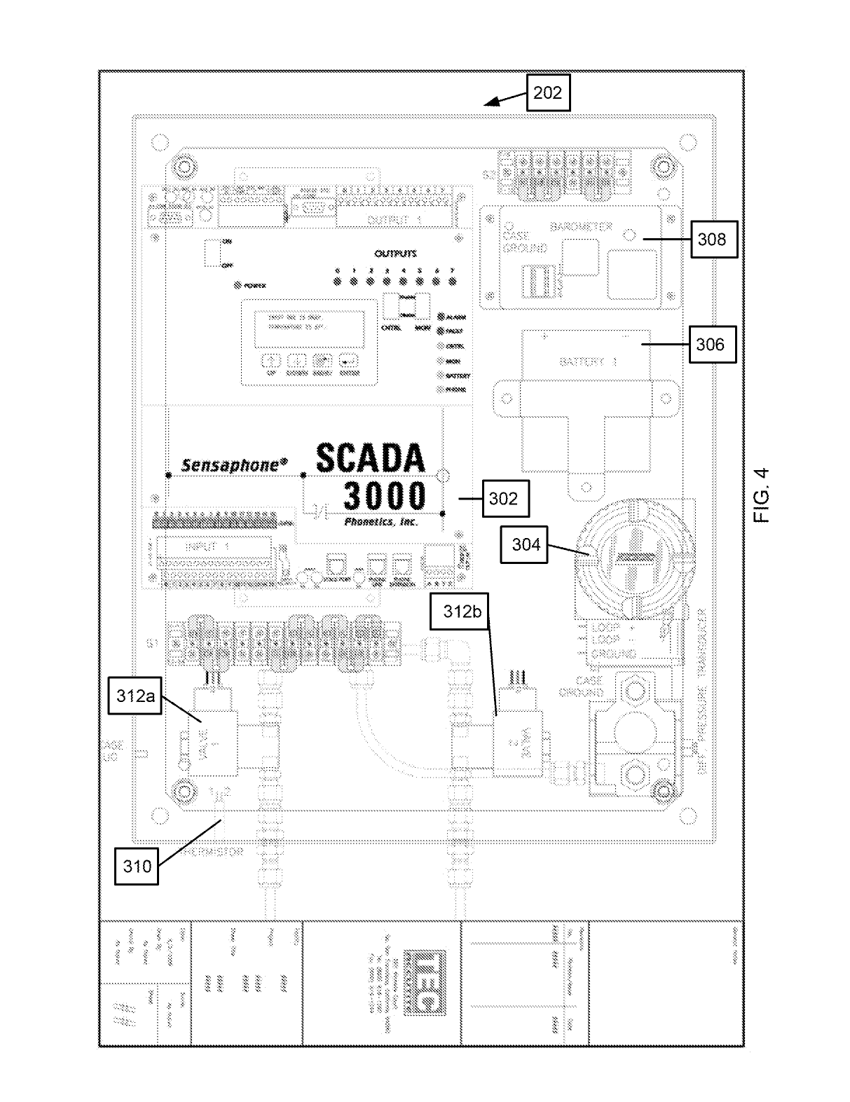

FIG. 4 is a schematic diagram of the pressure monitoring system 202 shown in FIGS. 2 and 3. As shown in FIG. 4, the pressure monitoring system 202 comprises a data collection computer 302 (e.g., a Sensaphone SCADA 3000), a differential pressure transducer 304, a battery 306, a barometric pressure recorder 308, a temperature transducer 310, and a two-valve calibration system comprising first and second valves 312a, 312b.

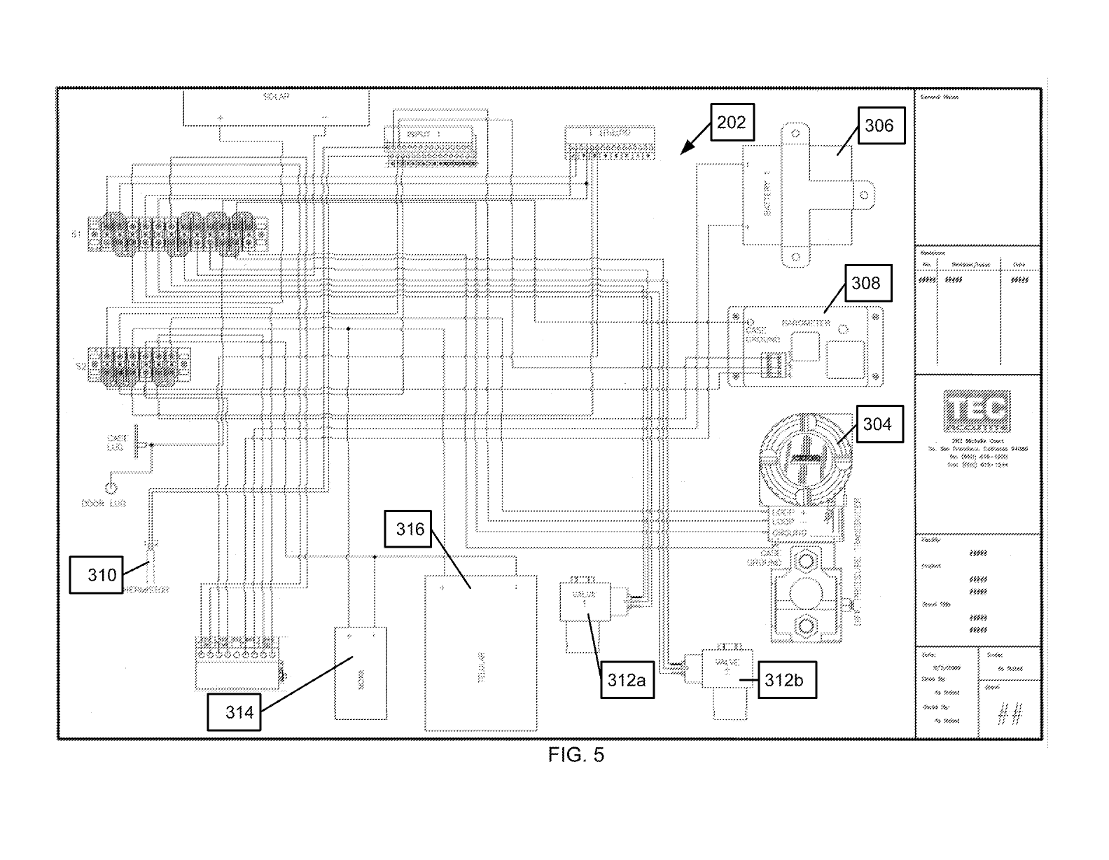

FIG. 5 is a wiring diagram for one aspect of the pressure monitoring system 202 shown in FIGS. 2-4. The various components of the pressure monitoring system 202 are electrically interconnected as shown in FIG. 5, including connections of the differential pressure transducer 304, the battery 306, the barometric pressure recorder 308, the temperature transducer 310 (e.g., thermistor), and the first and second valves 312a, 312b of the two-valve pressure calibration system. Also shown is the electrical interconnection of the serial server device 314 (MOXA) and the cellular modem 316 (e.g., Tellular) to the data collection computer 302.

The pressure monitoring system 202 allows online data access with auto alarm notifications and record-keeping to expand the management usefulness. Once deployed, the pressure monitoring system 202 may collect data continuously.

The pressure monitoring system 202 measures and records the differential pressure in the ullage space of manifolded tank systems, compared to atmospheric pressure, using a differential pressure sensor 304, such as, for example, a Viatran IDP10A sensor, measures and records the barometric pressure using a barometric pressure recorder 308, such as, for example, a R. M. Young model 61302L barometer, and measures and records the ambient temperature using a temperature transducer 310, such as, for example, a Sensaphone FGD 104 temperature probe. Pressure data is taken at a rate of, for example, one data point per second and logged into the data collection computer 302. The deployed pressure monitoring system 302 may be powered from the electrical grid or may be solar powered. The deployed system may be in communication with a TEC server using a modem 316, such as, for example, a Telular SX7T GSM router, which may be operated using AC power, and connected through CAT-5 cabling. Alarms are set to notify the operators and other stakeholders of out-of-compliance occurrences, and the pressure monitoring system 202 also produces monthly reports in both graphical and tabular, for example, Excel® spreadsheet, formats.

Equivalence of Equipment and Procedures to Requirements of TP-201.7

3. Biases and Interferences

3.1 Location. The sensors and other equipment may be housed in a metal enclosure or housing 300, such as, for example, a NEMA-4 housing (Weigand 4120206) with steel backplane and rubber gaskets. The sensor enclosure may be mounted so that the point of measurement of tank pressure is at the manifolded vent pipe.

3.2 Ambient Temperature probe mounting. The temperature probe 310, such as, for example, a temperature transducer, may be installed within a radiation shield protruding from the bottom of the housing 300, which is mounted at a height greater than 5 feet above grade.

3.3 Pressure Transducer mounting. The transducer may be mounted in the housing or enclosure 300, avoiding direct sunlight.

4. Sensitivity, Range and Precision

4.1 Electronic Pressure Transducer: The differential pressure transducer 304, such as, for example, a Viatran Model IDP10A, preferably is rated to meet or exceed the sensitivity, range and accuracy of the listed requirements in GARB TP-201.7. For example, the transducer may have a pressure sensitivity of 0.001 inches of water, have a pressure range of 20 inches water, and have an accuracy of 0.05 percent of the full pressure range.

4.2 The barometric pressure recorder 308, such as, for example, a R. M. Young model 61302L, preferably is rated to meet or exceed the sensitivity, range and accuracy of the listed requirements. For example, the barometric pressure recorder may have a pressure sensitivity of 0.2 millibars, have a full scale pressure range of 1100 millibars, and have an accuracy of 0.05% of the full scale pressure range.

4.3 Temperature Probe. The temperature transducer 310, such as, for example, a Sensaphone FGD104 or a VWR Scientific thermocouple type K, preferably meets or exceeds the sensitivity, range and accuracy of the listed requirements. For example, the temperature range may be 0-150° F. and the accuracy may be +/−0.1 degree F.

4.4 Data Acquisition System. The data collection computer 302, such as, for example, a Sensaphone 3000 SCADA system, preferably meets or exceeds requirements of method. For example, it may include up to 8 channels of information logging at up to 1 point per second and may store up to 27 days of data. Data may be transmitted to the server once per hour. However, if communication is down, the data collection computer 302 may store the data for eventual download.

5. Equipment. A list of example equipment that may be used to assemble a data collection computer 302 is included below.

5.1 Differential Pressure Transducer 304. Viatran Model IDP10L.

5.2 Barometric Pressure Recorder 308. R. M. Young model 61302L.

5.3 Data Collection Computer 302. Sensaphone SCADA 3000 or a Habey BIS 6620 fanless industrial solid state computer. Data is stored in Excel® or graphical format.

5.4 Solar Panel 208. BP Solar NEA 80J and Solar controller. 150 AH gel filled battery mounted in NEMA-4 metal container. Optionally, the pressure monitoring system operates on AC power.

5.5 Modem 316. Telular SX7T wireless GSM router is used. A high gain antenna is mounted above the panel. Optionally, the pressure monitoring system 202 is connected through CAT 5 wiring).

5.6 Housing 300: Weigand NEMA-4 rated metal enclosure.

5.7 Leak decay: performed by the requirements of GARB TP-201.3.

5.8 Pressure port fitting. The factory threaded 2″×4″ nipple was drilled and tapped for ¼ NPT fitting to Swagelok tube fitting to the inlet fitting, without modifications to the GDF.

5.9 Analog-to-digital converters. Various analog-to-digital converters may be included from the sensors to the data collection computer 302. For example, a Weeder Technologies WTAIN-M analog input device may be used to convert analog signals from the differential pressure transducer 304 and the barometric pressure recorder 308 to digital signals and to send the converted digital signals to the data collection computer 302. Also, for example, a Weeder Technologies WTTI-M thermocouple input device may be used to convert analog signals from the temperature transducer 310 to digital signals and to send the converted digital signals to the data collection computer 302.

5.9 Output relay device. The pressure monitoring system 302 may include a relay output device, such as, for example, a Weeder Technologies WDOT-M relay output device, identified in FIG. 3B as reference number 321. The output relay device 321 may be controlled by the data collection computer 302 and may, for example, control opening and closing of valves 312a and 312b. The output relay device 321 also may, for example, reset the modem 316.

6. Pre-Test Procedures

6.1 Perform a pressure decay test using Test Procedure TP-201.3C. This test was performed by a licensed third party vendor. All tanks were properly manifolded.

6.2 Data Acquisition system and transducers may be installed in a water proof enclosure or housing 300. The batteries 306 also may be installed in the enclosure or housing 300. A liquid trap is may be installed in the line from the vent stack, with an auto-operated valve set to empty the line trap of liquid and to also check the zero calibration on a weekly basis.

6.3 Installation of enclosures was in accordance with the requirements of section 6.3. All enclosures were high enough to be out of the way of operations and not affected by normal activities.

6.4 The pressure line installation used the described nipple and stainless steel lines. Swagelok fittings may be used, and where NPT fittings were made, Teflon tape may be used. The nipple may be torqued, for example, to 40 foot lbs.

6.5 PV valve may be installed per manufacturer's instructions prior to TP-201.3 testing.

6.6 All pressure monitoring devices may be calibrated at the factory and may include calibration certificates. NIST traceable were used in factory calibrations. Records of the calibrations are kept with the instrument files.

6.7 Data readings may be compared to data readings from different instrument to verify the data acquisition readings.

6.8 A TP-201.3 test may be conducted by a licensed third party vendor prior to operation.

6.9 Excess pressure may be bled off at the end of the test.

Operation of the Systems

The continuous pressure monitoring system 202 may be designed and built for automatic/un-manned continuous operation. Data is collected from all channels and stored on the data collection computer 302. At intervals of 1 hour or shorter, the data collection computer 302 is polled by software running on servers at the TEC headquarters, written in database format, and made available through proprietary methods for analysis and presentation. This automated polling into remote computers allows the 27 day storage period to be expanded indefinitely through the 1 hour rolling downloads. In addition, the data collection computer 302 in the TEC NV201 system 202 is set to send e-mail alarms when any of the following conditions occur:

1: The measured differential pressure exceeds 3.00 inches water column pressure, indicating venting of gasoline vapor to the atmosphere. This condition also may indicate that the PV valve is stuck in the closed position.

2: The measured differential pressure remains near zero for a period that exceeds 3 hours, indicating a possible open system, such as, for example, a PV valve stuck in an open position.

3: The measured differential pressure is less than −8.00 inches water column pressure, indicating a dangerous vacuum condition that may cause the UST to collapse. This condition also may indicate that the PV valve is stuck in the closed position.

The client/RP, system operator, service/maintenance provider, and other designated stakeholders (such as but not limited to fuel suppliers and fuel delivery companies) may be notified by e-mail of these conditions, and a graphical representation is generated of the event. Typically, the conditions that cause an alarm usually coincide with fuel deliveries or de-fueling events. The feedback from the system allows for the management teams to refine the operation and delivery processes, such as, for example, correctly using Stage I vapor return lines and noting and correcting any equipment failures, so that over pressure events do not occur.

Fugitive Emissions

The accuracy and continuity of the data generated by the pressure monitoring system 202 allows for the calculation of fugitive emissions using methods outlined in Procedure TP-201-2F, and GARB Project Number V-08-012.

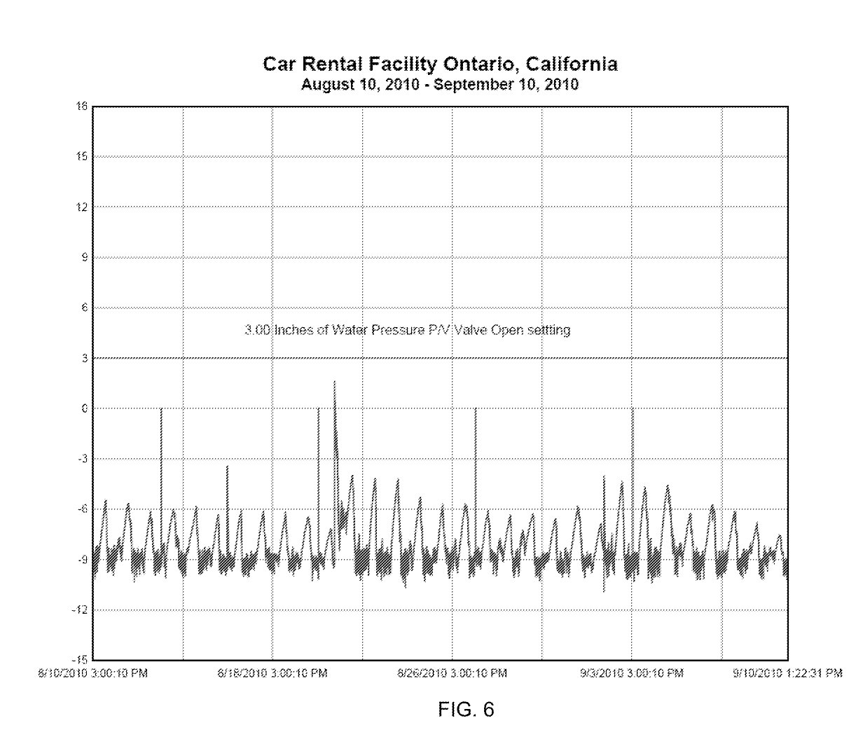

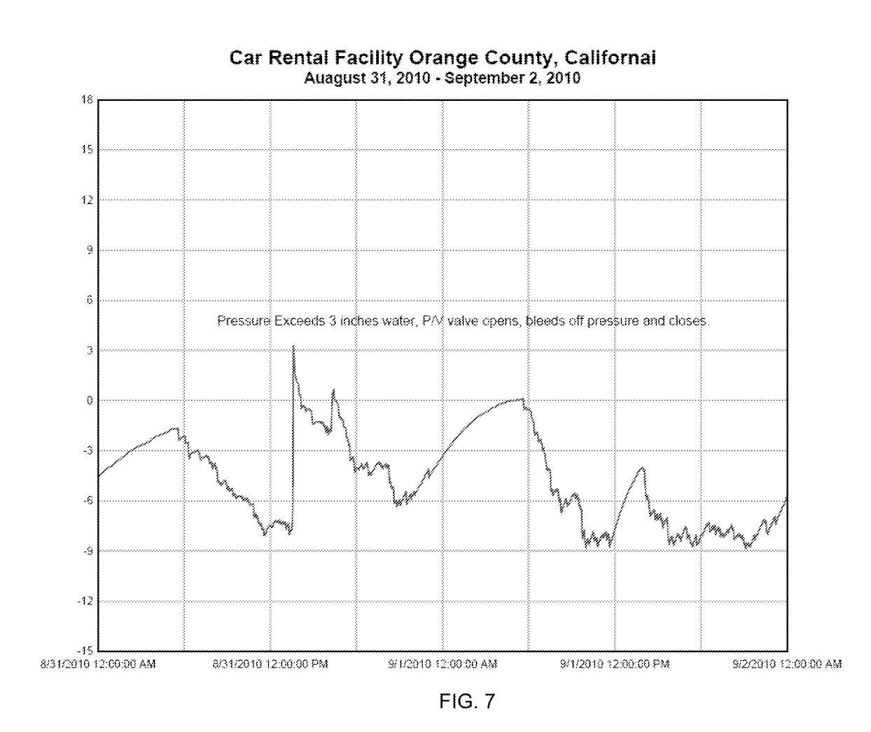

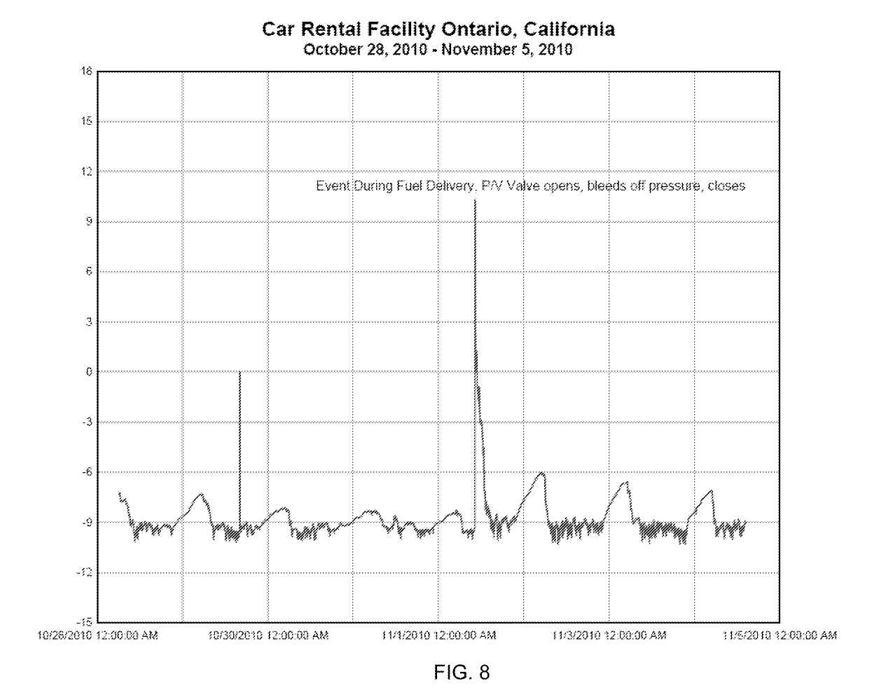

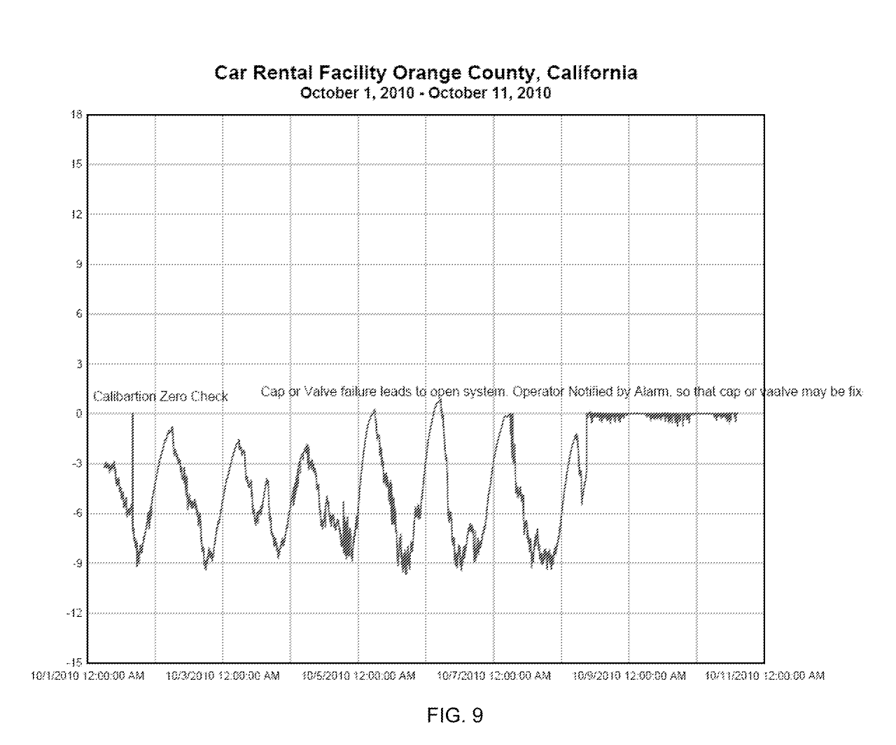

FIGS. 6-9 are graphical illustrations of pressure data collected using one aspect of the pressure monitoring system 202 shown and described in connection with FIGS. 2-4 for various installations. The date and time when a pressure reading was recorded is shown along the horizontal axis and fuel storage tank pressure in inches of water column is shown along the vertical axis.

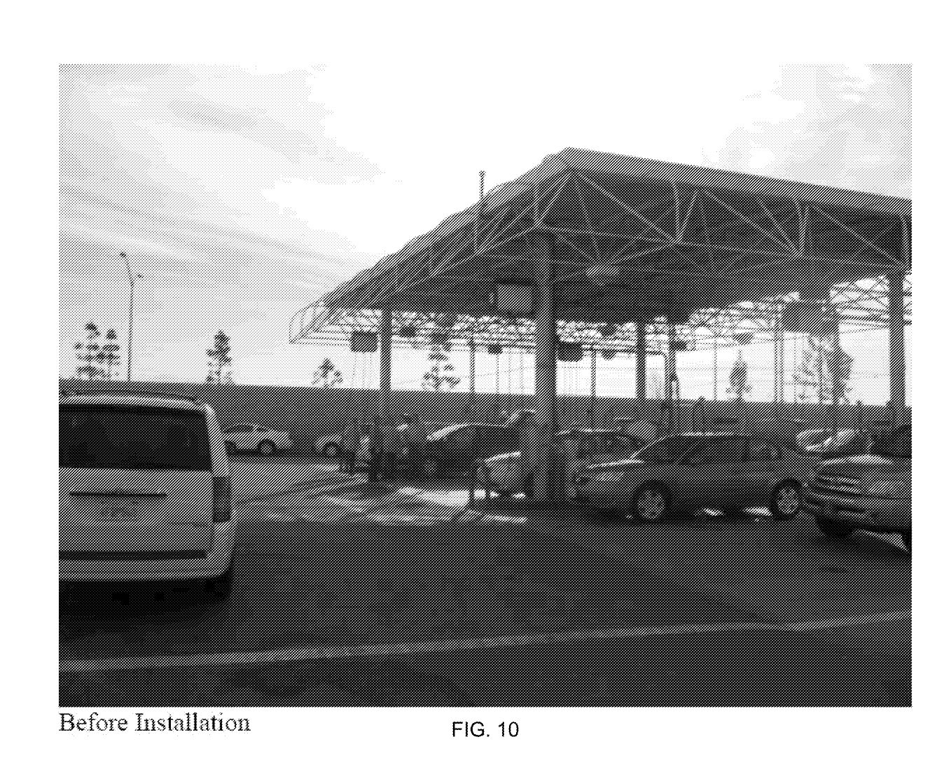

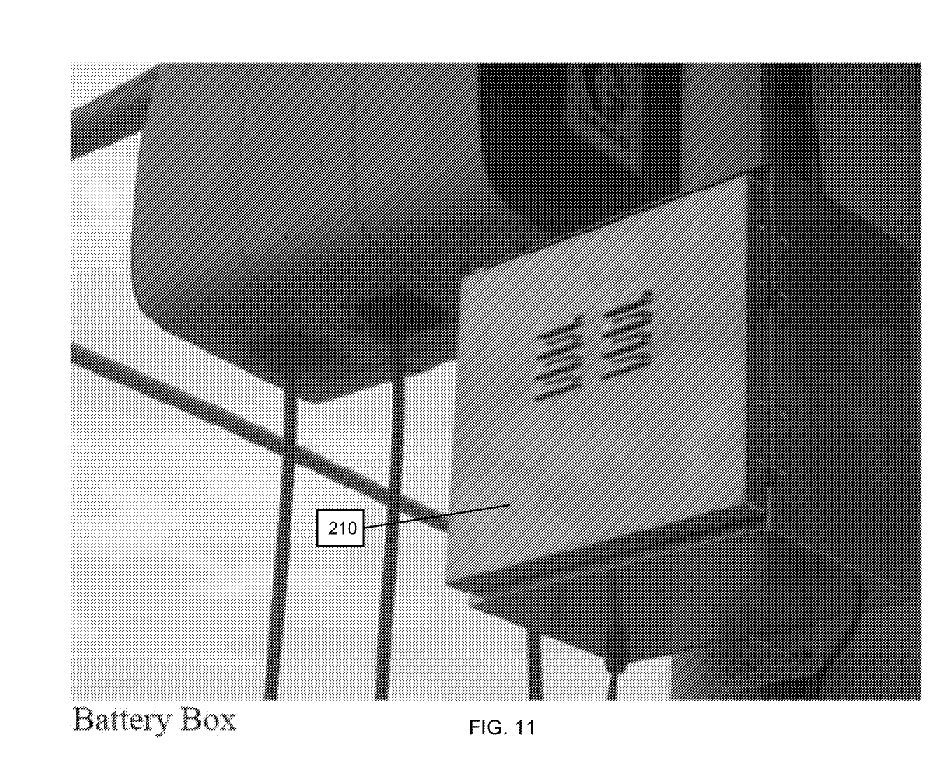

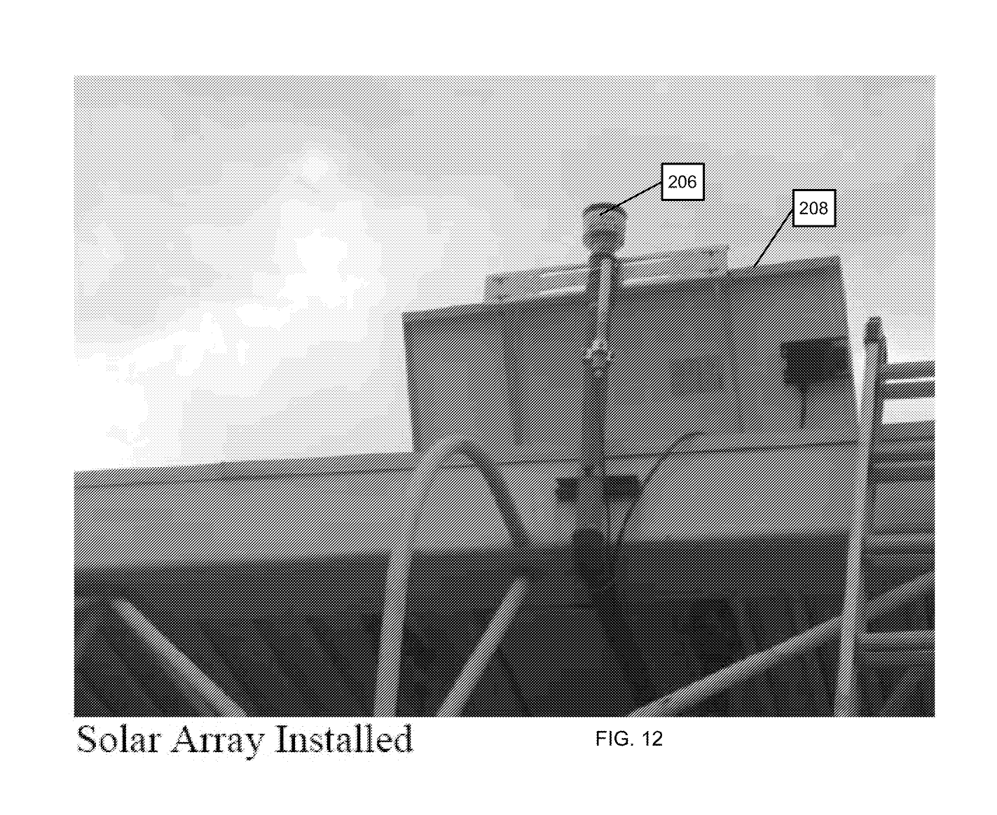

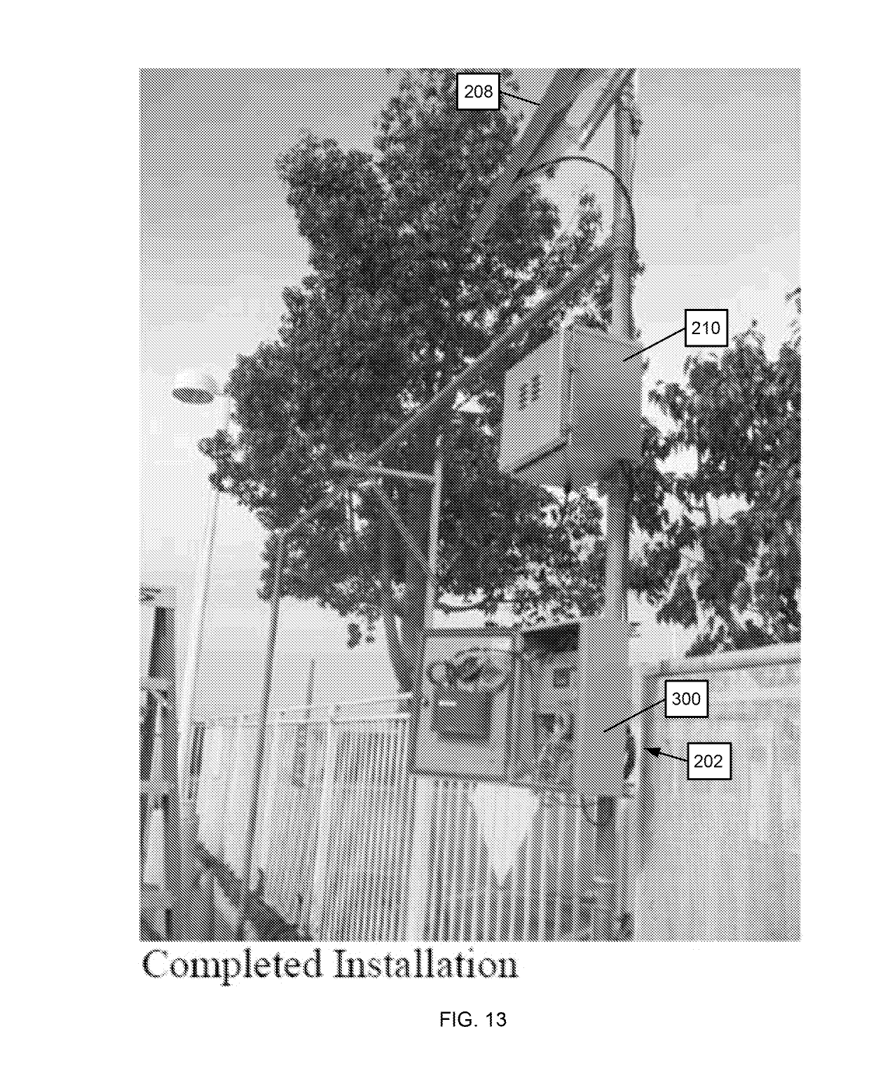

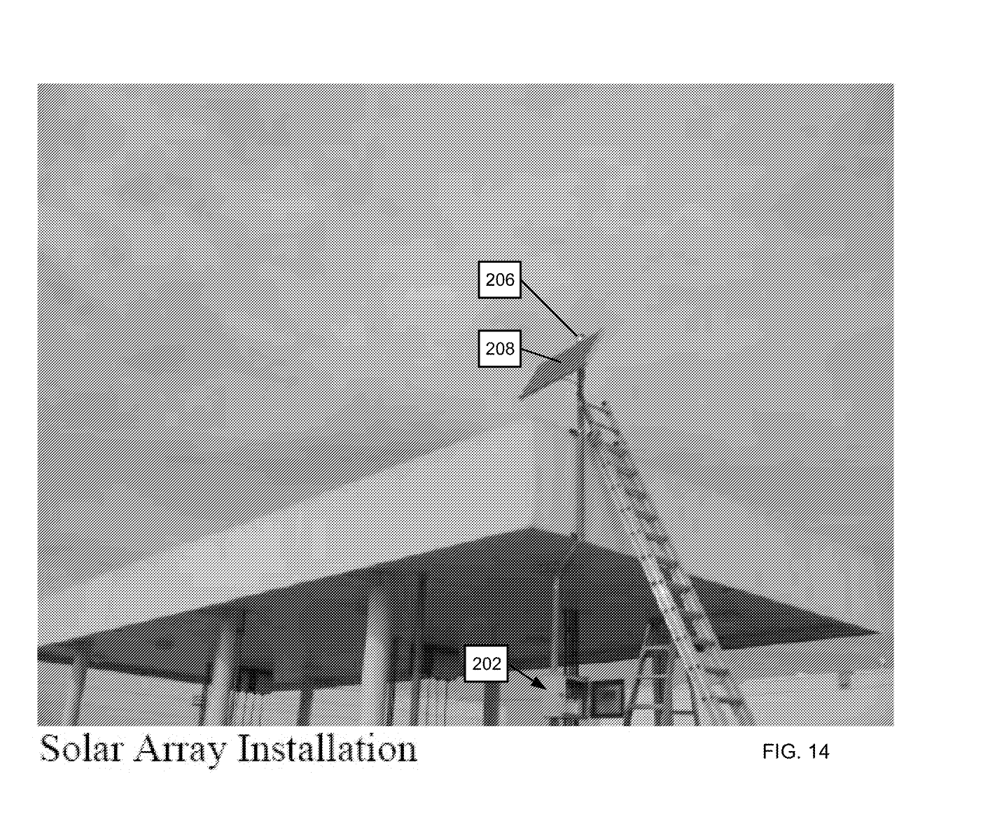

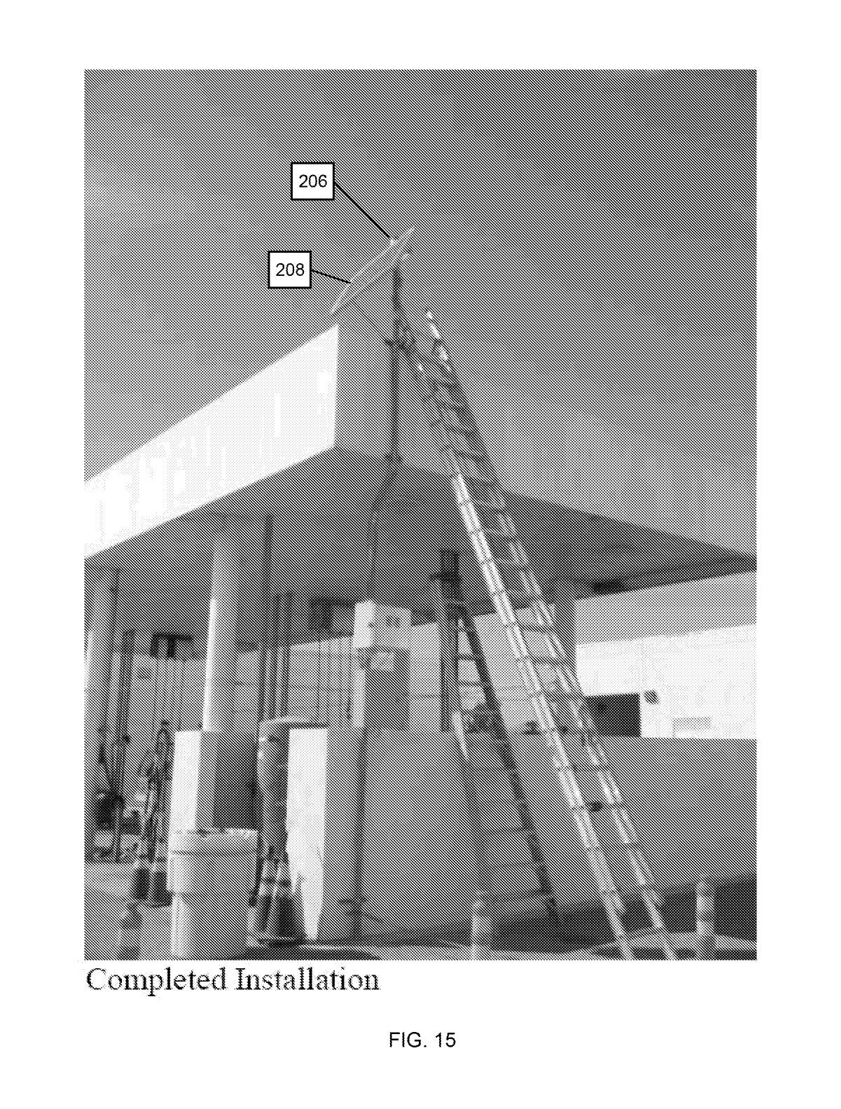

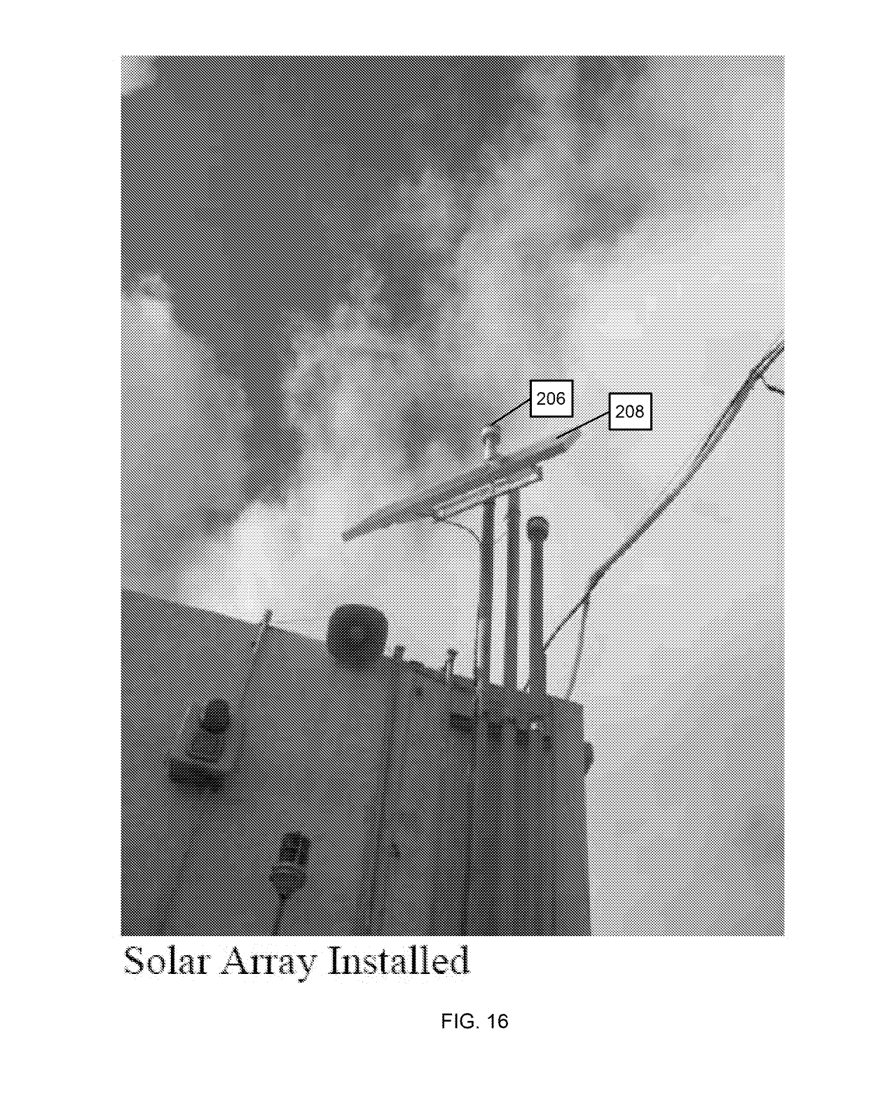

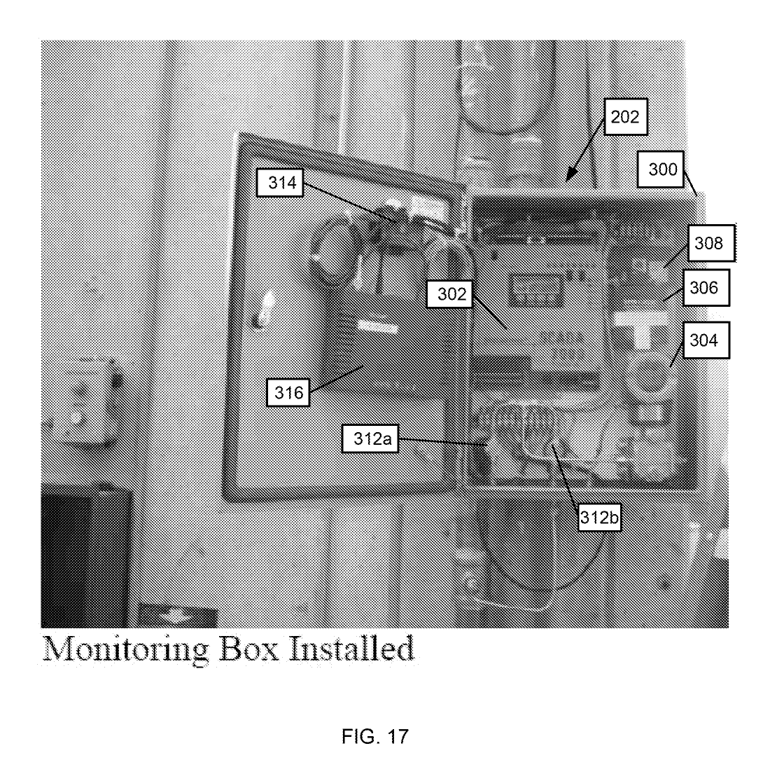

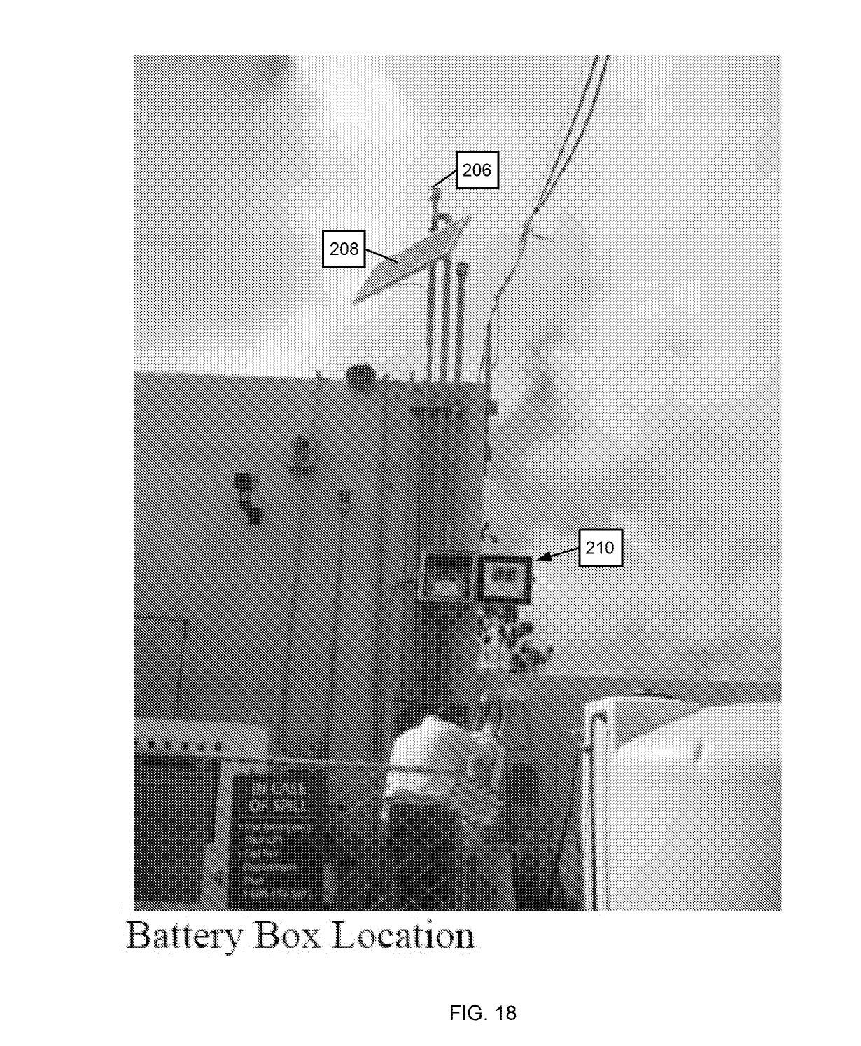

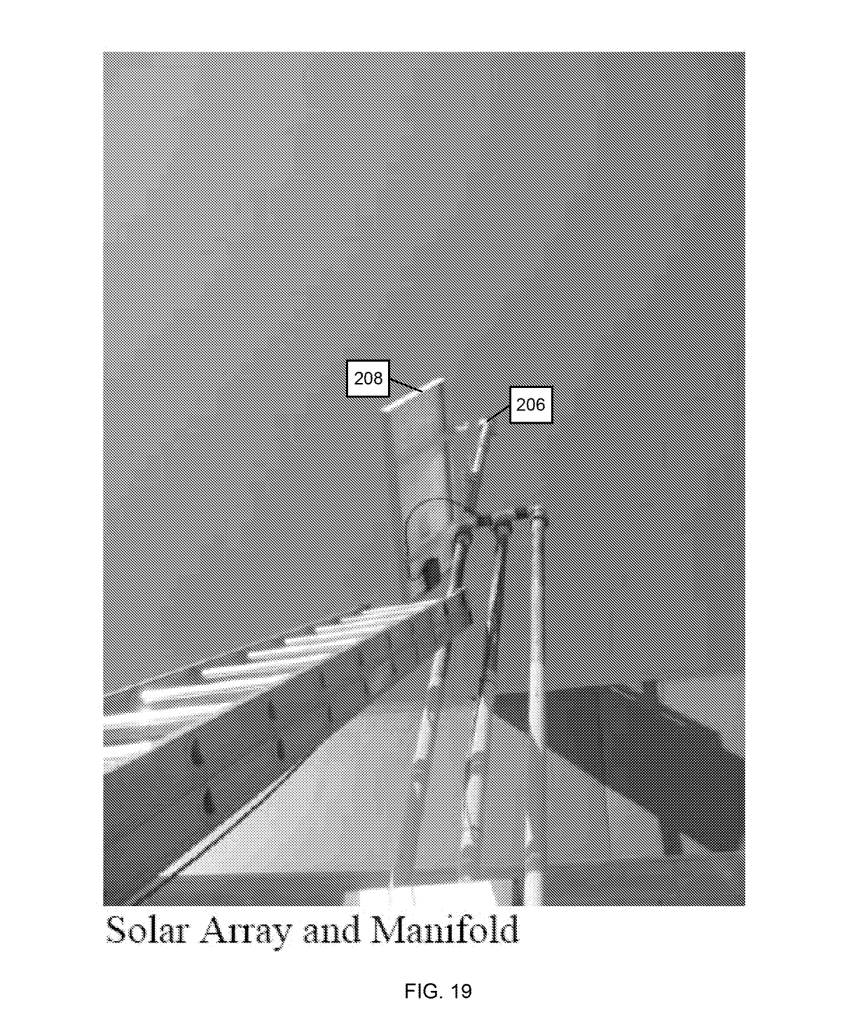

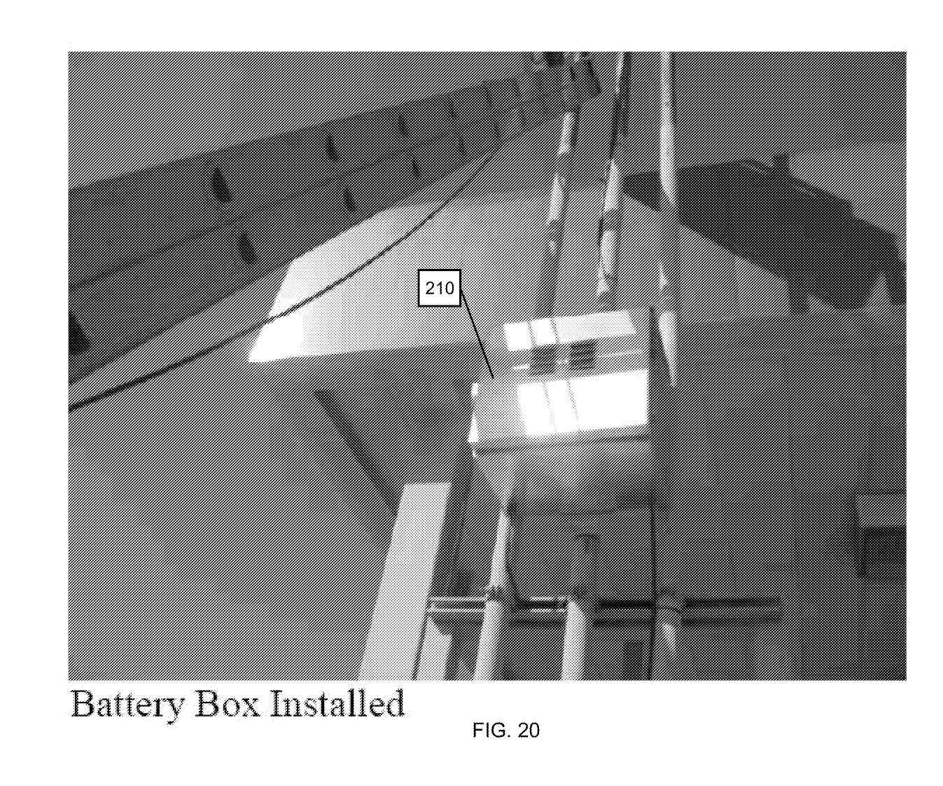

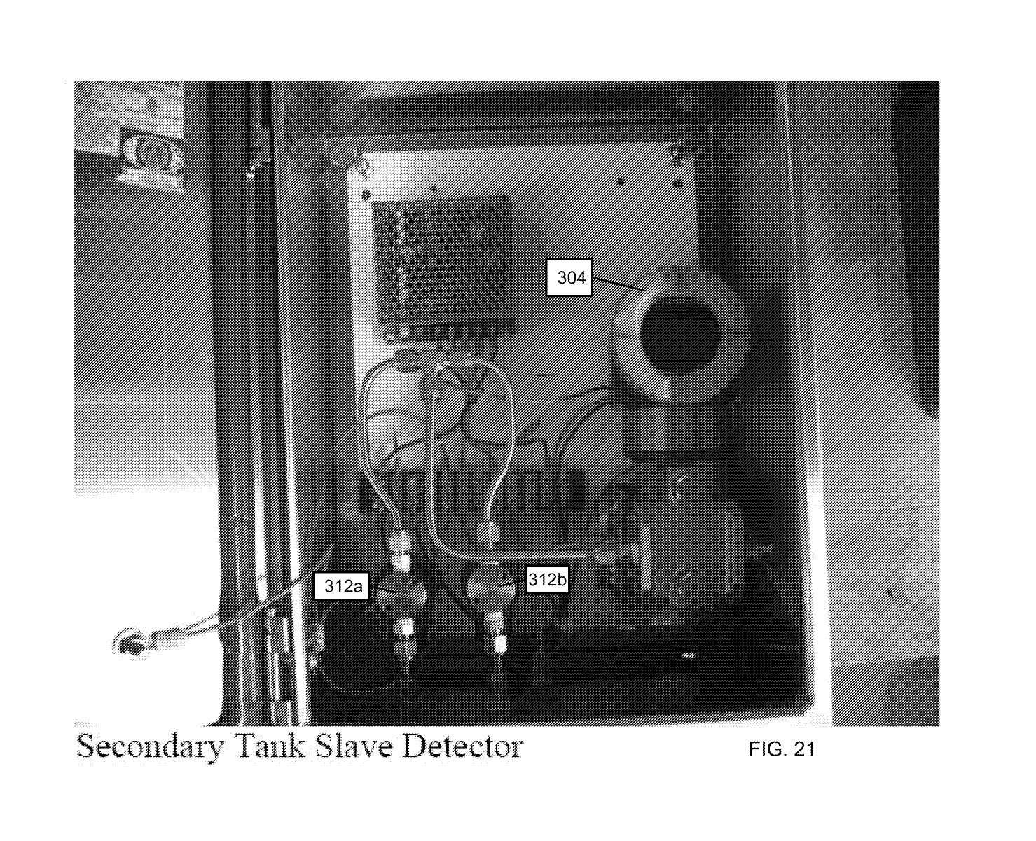

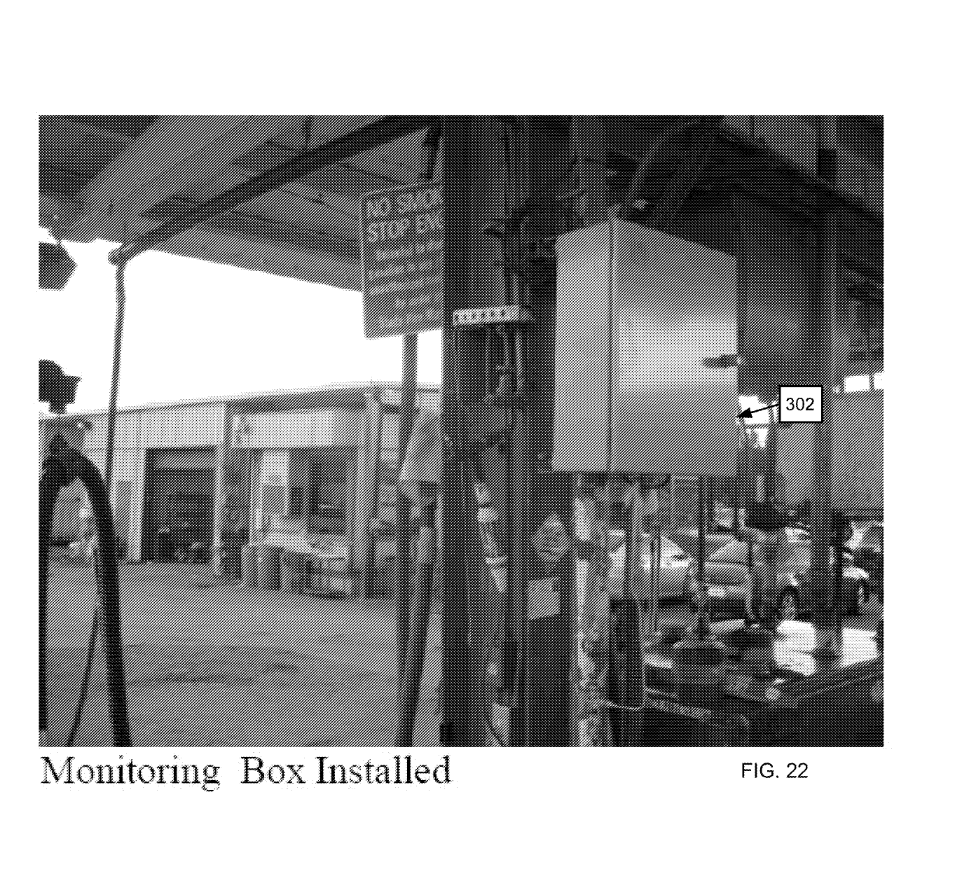

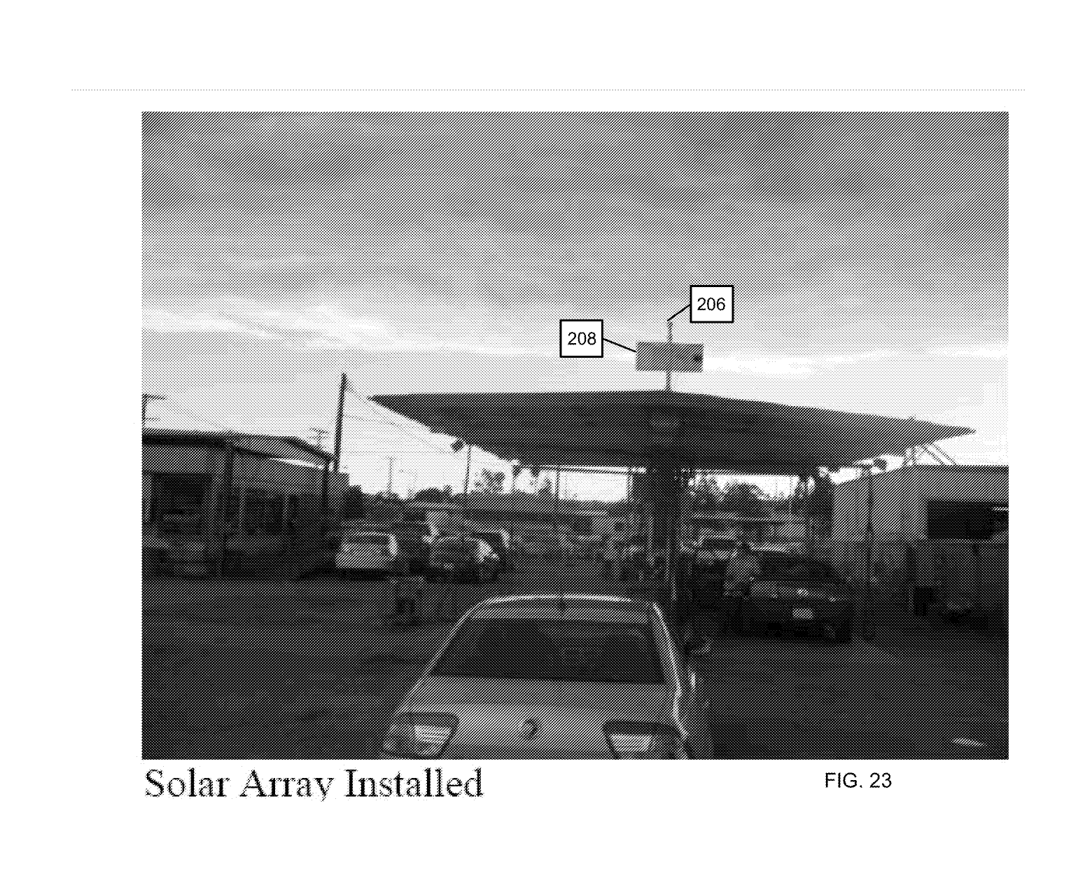

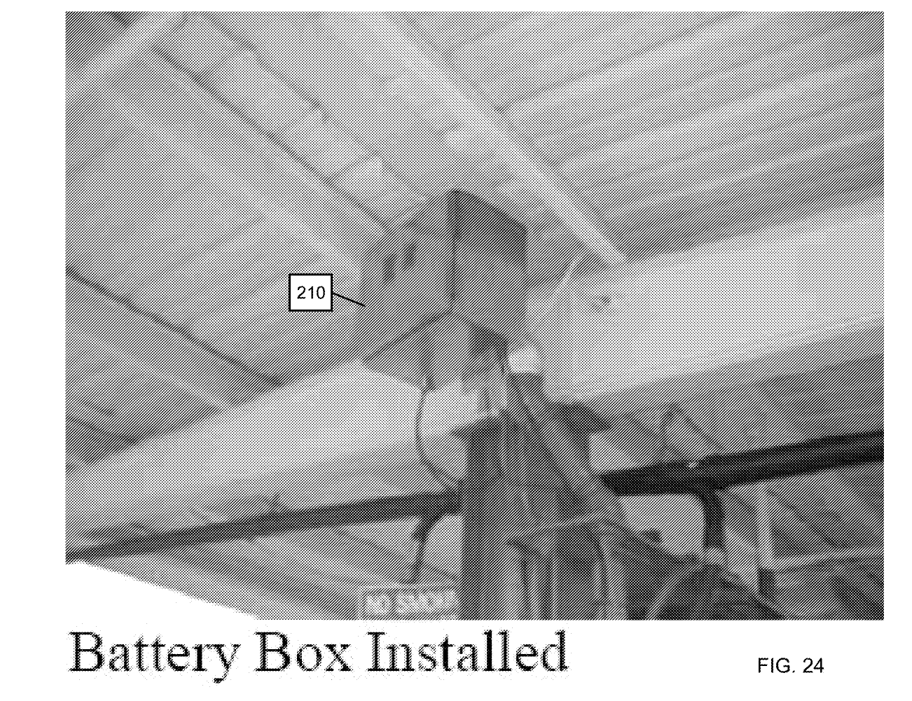

FIGS. 10-24 illustrate installations of various aspects of the pressure monitoring system 202 shown in FIGS. 2-5 at various gasoline dispensing facilities (GDFs). Like numerals represent aspects of the pressure monitoring system 202 described above.

The following description is directed to various aspects of data handling of one aspect of the pressure monitoring system 202 described above in connection with FIGS. 2-5. Accordingly, with reference back to FIGS. 2-5, in one aspect, the pressure monitoring system 202 may operate on a continuous basis, taking data from three sensors: a differential Pressure Transducer 304, an electronic barometric pressure recorder 308, and a temperature transducer 310. The data is stored in the data collection computer 302, which can store the temperature and pressure data, for example, up to 27 days of data. The data acquisition is controlled by a computer program that records values in the data collection computer 302. The data collection computer 302 can be addressed and the data retrieved in several ways. For example, an RS-232 serial port may be included on the data collection computer 302 and configured for an external computer terminal to make a direct connection to the data collection computer 302. The external computer terminal then can download the data, make changes to the program, and control all the devices attached to the system.

The data collection computer 302 also may be connected to a remote site. For example, the data collection computer 302 may include a phone line connection that can be used to connect an external computer terminal to the data collection computer 302 and perform the above functions. This phone line connection, however, may be very slow, requires a land line, and needs to be dialed up. For faster, more reliable and continuous access and control, the data collection computer 302 may be connected to an internet connection, such as an Ethernet connection. For example, the RS-232 serial port may be connected to a serial device server 314. The serial device server 314 converts communications from serial to TCP/IP. The serial device server 314 may be connected directly to the Internet to provide connectivity to the data collection computer 302. Many installations may not have access to Internet connectivity, so connectivity can be acquired by connecting the serial device server 314 to a cellular wireless broadband router 316. The cellular wireless broadband router 316 may provide internet addressable TCP/IP connectivity to the data collection computer 302.

As shown in FIG. 26, a compliance system 500 may be connected to a plurality of pressure monitoring systems 502a-n. Each pressure monitoring system 502a-n may be associated with a separate UST (not shown) and includes a respective data collection computer 504a-n. As data is retrieved from each data collection computer 504a-n, the oldest data residing on the data collection computers 504a-n may be deleted to make room for newer data. The host computer 506 may use a port emulator program to create a virtual port for each of the data collection computers 504a-n via an RS-232 serial port. In this way the host computer 506 is in continuous connection with each of the data collection computers 504a-n. The host computer 506 may be configured to poll each of the data collection computers 504a-n at a regular interval, for example, every hour, and download all of the data. In addition, the connection allows the host computer 506 to act as an email server to send alarm notices to the stakeholders. The alarm notice emails are not part of the polled data, but are immediately triggered by one of the data collection computers 504a-n while communicating with the host computer 506 and resent with custom content to the stakeholders.

Once each of the data collection computers 504a-n device has been polled by the software on the host computer 506, the data is stored in a database on that host computer 506. Additional hourly scheduled processes transfer these database files to a web server 508 where the data is imported into an online database 510. Through this online database 510, historical details of the readings from the data collection computers 504a-n can be viewed from anywhere in the world on a computer terminal 512 via the web server 508. This data is viewable on the computer terminal 512 in either a graphical or a tabular format. The range of data selected for viewing on the computer terminal 512 is user-modifiable via an integrated date & time interface for selecting both the starting date & time as well as the ending date and time on the web page. There is also the ability for a user selectable range of data, selected via the same integrated date and time interface on the web page, to be exported to a spreadsheet file which can be downloaded to a computer terminal 512 for further use by that user.

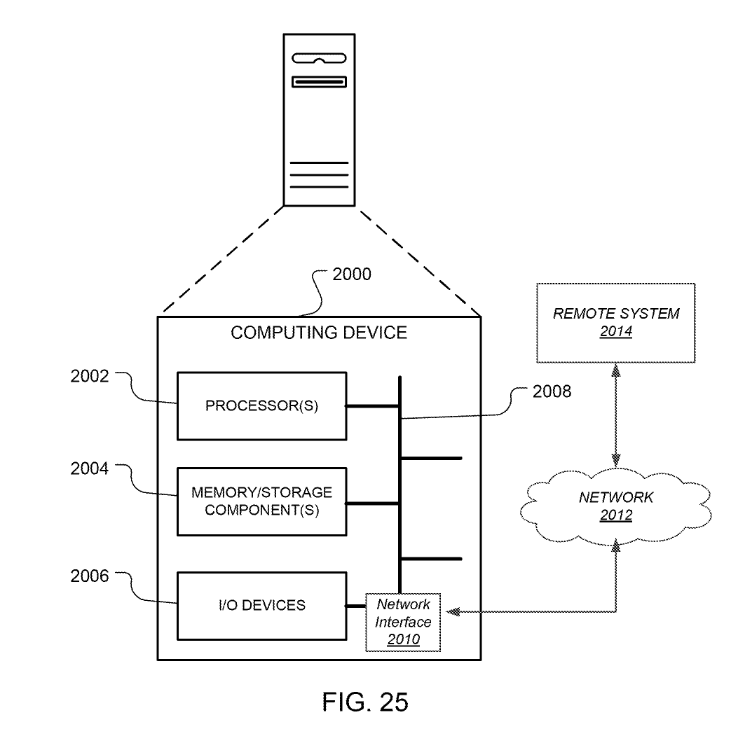

FIG. 25 illustrates one aspect of a host computing device 2000 which can be used in one embodiment of a system to implement the various described embodiments for communicating with the pressure monitoring system 202 comprising the data collection computer 302. The host computing device 2000 may be employed to implement one or more of the host computing devices and or servers for receiving data from the data collection computer 302. For the sake of clarity, the host computing device 2000 is illustrated and described here in the context of a single computing device. It is to be appreciated and understood, however, that any number of suitably configured computing devices can be used to implement any of the described embodiments. For example, in at least some implementations, multiple communicatively linked computing devices are used. One or more of these devices can be communicatively linked in any suitable way such as via one or more networks. One or more networks can include, without limitation: the Internet, one or more local area networks (LANs), one or more wide area networks (WANs) or any combination thereof. Viewing of the data is possible through any web-connected device, including but not limited to fixed or portable computers, smart phones, tablet PCs, and/or pads.

In this example, the host computing device 2000 comprises one or more processor circuits or processing units 2002, one or more memory circuits and/or storage circuit component(s) 2004 and one or more input/output (I/O) circuit devices 2006. Additionally, the host computing device 2000 comprises a bus 2008 that allows the various circuit components and devices to communicate with one another. The bus 2008 represents one or more of any of several types of bus structures, including a memory bus or memory controller, a peripheral bus, an accelerated graphics port, and a processor or local bus using any of a variety of bus architectures. The bus 2008 may comprise wired and/or wireless buses.

The processing unit 2002 may be responsible for executing various software programs such as system programs, applications programs, and/or modules to provide computing and processing operations for the host computing device 2000. The processing unit 2002 may be responsible for performing various voice and data communications operations for the host computing device 2000 such as transmitting and receiving voice and data information over one or more wired or wireless communications channels. Although the processing unit 2002 of the host computing device 2000 is shown with a single processor architecture, it may be appreciated that the host computing device 2000 may use any suitable processor architecture and/or any suitable number of processors in accordance with the described embodiments. In one embodiment, the processing unit 2002 may be implemented using a single integrated processor.

The processing unit 2002 may be implemented as a host central processing unit (CPU) using any suitable processor circuit or logic device (circuit), such as a as a general purpose processor. The processing unit 2002 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 2002 may be coupled to the memory and/or storage component(s) 2004 through the bus 2008. The memory bus 2008 may comprise any suitable interface and/or bus architecture for allowing the processing unit 2002 to access the memory and/or storage component(s) 2004. Although the memory and/or storage component(s) 2004 may be shown as being separate from the processing unit 2002 for purposes of illustration, it is worthy to note that in various embodiments some portion or the entire memory and/or storage component(s) 2004 may be included on the same integrated circuit as the processing unit 2002. Alternatively, some portion or the entire memory and/or storage component(s) 2004 may be disposed on an integrated circuit or other medium (e.g., hard disk drive) external to the integrated circuit of the processing unit 2002. In various embodiments, the computing device 2000 may comprise an expansion slot to support a multimedia and/or memory card, for example.

The memory and/or storage component(s) 2004 represent one or more computer-readable media. The memory and/or storage component(s) 2004 may be implemented using any computer-readable media capable of storing data such as volatile or non-volatile memory, removable or non-removable memory, erasable or non-erasable memory, writeable or re-writeable memory, and so forth. The memory and/or storage component(s) 2004 may comprise volatile media (e.g., random access memory (RAM)) and/or nonvolatile media (e.g., read only memory (ROM), Flash memory, optical disks, magnetic disks and the like). The memory and/or storage component(s) 2004 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 2006 allow a user to enter commands and information to the host computing device 2000, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The host computing device 2000 may comprise an alphanumeric keypad coupled to the processing unit 2002. The keypad may comprise, for example, a QWERTY key layout and an integrated number dial pad. The host computing device 2000 may comprise a display coupled to the processing unit 2002. The display may comprise any suitable visual interface for displaying content to a user of the host computing device 2000. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 2002 may be arranged to provide processing or computing resources to the host computing device 2000. For example, the processing unit 2002 may be responsible for executing various software programs including system programs such as operating system (OS) and application programs. System programs generally may assist in the running of the host computing device 2000 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The host computing device 2000 may comprise other system programs such as device drivers, programming tools, utility programs, software libraries, application programming interfaces (APIs), and so forth.

The host computing device 2000 also includes a network interface 2010 coupled to the bus 2008. The network interface 2010 provides a two-way data communication coupling to a local network 2012. For example, the network interface 2010 may be a digital subscriber line (DSL) modem, satellite dish, an integrated services digital network (ISDN) card or other data communication connection to a corresponding type of telephone line. As another example, the communication interface 3010 may be a local area network (LAN) card effecting a data communication connection to a compatible LAN. Wireless communication means such as internal or external wireless modems may also be implemented.

In any such implementation, the network interface 2010 sends and receives electrical, electromagnetic or optical signals that carry digital data streams representing various types of information, such as the selection of goods to be purchased, the information for payment of the purchase, or the address for delivery of the goods. The network interface 2010 typically provides data communication through one or more networks to other data devices. For example, the network interface 2010 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 2010, which carry the digital data to and from the host computing device 2000, are exemplary forms of carrier waves transporting the information.

The host computing device 2000 can send messages and receive data, including program code, through the network(s) and the network interface 2010. In the Internet example, a server might transmit a requested code for an application program through the internet, the ISP, the local network (the network 2012) and the network interface 2010. In accordance with the invention, one such downloaded application provides for the identification and analysis of a prospect pool and analysis of marketing metrics. The received code may be executed by processor 2004 as it is received, and/or stored in storage device 2010, or other non-volatile storage for later execution. In this manner, host computing device 2000 may obtain application code in the form of a carrier wave.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are comprised within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and embodiments as well as specific examples thereof, are intended to encompass both structural and functional equivalents thereof. Additionally, it is intended that such equivalents comprise both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as when it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the disclosed embodiments and does not pose a limitation on the scope otherwise claimed. No language in the specification should be construed as indicating any non-claimed element essential to the practice of the claimed subject matter. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or embodiments disclosed herein are not to be construed as limitations. Each group member may be referred to and claimed individually or in any combination with other members of the group or other elements found herein. It is anticipated that one or more members of a group may be comprised in, or deleted from, a group for reasons of convenience and/or patentability.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

What is claimed is:

1. A data collection system for a liquid storage tank, comprising:
a pressure sensor, configured to measure vapor pressure within the liquid storage tank;
a data recorder in communication with the pressure sensor, the data recorder configured to record the vapor pressure measurements received from the pressure sensor; and
a data transmitter in communication with the data recorder, the data transmitter configured to receive requests for recorded vapor pressure measurements from a computer server and to send the recorded vapor pressure measurements to the computer server.

2. The data collection system of claim 1, wherein the pressure sensor is a differential pressure sensor configured to measure vapor pressure within the liquid storage tank compared to atmospheric pressure.

3. The data collection system of claim 1, further comprising a temperature sensor arranged to measure ambient air temperature;
wherein the data recorder is in communication with the temperature sensor, the data transmitter being further configured to record temperature measurements received from the temperature sensor; and
wherein the data transmitter is further configured to receive requests for recorded temperature measurements from the computer server and to send the recorded temperature measurements to the computer server.

4. The data collection system of claim 1, further comprising a barometric pressure sensor arranged to measure ambient air pressure;
wherein the data recorder is in communication with the barometric pressure sensor, the data transmitter being further configured to record barometric pressure measurements received from the barometric pressure sensor; and
wherein the data transmitter is further configured to receive requests for recorded barometric pressure measurements from the computer server and to send the recorded barometric pressure measurements to the computer server.

5. The data collection system of claim 1, wherein the data recorder comprises a computer that stores the vapor pressure measurements in memory.

6. The data collection system of claim 1, wherein the data transmitter comprises a wireless modem.

7. A computer server comprising:
a computer comprising a computer processor, memory, and a network connection;
the computer configured to request vapor pressure measurements of a liquid storage tank recorded by the data collection system, to receive the requested vapor pressure measurements, and to gather the received vapor pressure measurements in a database; and
the computer configured to send at least a portion of the data contained in the database to a web server upon a request for the portion of the data.

8. A web server comprising:
a computer comprising a computer processor, memory, and a network connection;
the computer configured to receive requests for data related to vapor pressure measurements of a liquid storage tank from computer terminals;
the computer configured to query a computer server for the requested data and to receive the requested data from the computer server; and
the computer configured to format the data for display on the computer terminal and to send the formatted data to the computer terminal.

9. A system for monitoring compliance of liquid storage tanks with pressure requirements, comprising:
first and second data collection systems configured to collect pressure data from a first liquid storage tank and a second liquid storage tank, respectively, each data collection system comprising:
a pressure sensor, configured to measure vapor pressure within the liquid storage tank;
a data recorder in communication with the pressure sensor, the data recorder configured to record the vapor pressure measurements received from the pressure sensor; and
a data transmitter in communication with the data recorder, the data transmitter configured to transmit the recorded vapor pressure measurements;
a computer server configured to receive the transmitted vapor pressure measurements from the first and second data collection systems and to gather together the measurements into a database; and
a web server configured to receive at least a portion of the data contained in the database from the computer server, to format the received data for display on a computer terminal, and to transmit the formatted data to the computer terminal.
